(19) United States
(12) Patent Application Publication
(10) Pub. No.: US 2024/0198670 A1
(43) Pub. Date: Jun. 20, 2024

(54) HEAD CHIP, LIQUID JET HEAD, AND LIQUID JET RECORDING DEVICE

(71) Applicant: SII Printek Inc., Chiba-shi (JP)

(72) Inventor: Hitoshi NAKAYAMA, Chiba-shi (JP)

(21) Appl. No.: 18/537,472

(22) Filed: Dec. 12, 2023

(30) Foreign Application Priority Data
Dec. 16, 2022 (JP) 2022-201245

(51) Int. Cl. B41J 2/14

(52) U.S. Cl. CPC B41J 2/14201

(57) ABSTRACT

A head chip, a liquid jet head, and a liquid jet recording device each capable of effectively transferring elastic energy to ink in a pressure chamber to increase pressure to be generated in the pressure chamber are provided. The head chip according to an aspect of the present disclosure includes a flow channel member in which a plurality of pressure chambers penetrating in a first direction is arranged in a second direction crossing the first direction, a first member which includes an actuator plate deformable in the first direction, and which is bonded on the flow channel member in a state of closing the pressure chambers from a first side in the first direction, and a second member which includes a jet hole plate provided with jet holes communicated with the pressure chambers, and which is bonded on the flow channel member in a state of closing the pressure chambers from a second side as an opposite side to the first side in the first direction. The flow channel member includes a partition wall configured to partition the pressure chambers adjacent to each other. The bonding area between the partition wall and the second member is larger than the bonding area between the partition wall and the first member.

### RELATED APPLICATIONS

This application claims priority to Japanese Patent application No. JP2022-201245 filed on Dec. 16, 2022, the entire content of which is incorporated herein by reference.

### BACKGROUND OF THE INVENTION

### 1. Field of the Invention

The present disclosure relates to a head chip, a liquid jet head, and a liquid jet recording device.

### 2. Description of the Related Art

A head chip to be installed in an inkjet printer is provided with a flow channel member provided with pressure chambers, and an actuator plate formed of a piezoelectric material which closes one surface of each of the pressure chambers (see, e.g., JPH10-58674A).

In the head chip of this kind, the volume of the pressure chamber is increased or decreased by deforming the actuator plate due with an electric field generated in the actuator plate. Thus, by a pressure variation being generated in the pressure chamber, ink in the pressure chamber is ejected through a nozzle hole.

Recently, with the view of an increase in nozzle density, the width of a portion (a partition wall) of partitioning the pressure chambers adjacent to each other out of the flow channel member tends to be narrowed. When the width of the partition wall is narrowed, the rigidity of the partition wall decreases. In this case, there is a possibility that elastic energy generated due to the deformation of the actuator plate is absorbed by the deformation of the partition wall when ejecting the ink. In other words, in the related-art head chip, it is difficult to effectively transfer the elastic energy to the ink in the pressure chamber, and there is a room for improvement in the point of increasing the pressure to be generated in the pressure chamber.

The present disclosure provides a head chip, a liquid jet head, and a liquid jet recording device each capable of effectively transferring the elastic energy to the ink in the pressure chamber to increase the pressure to be generated in the pressure chamber.

### SUMMARY OF THE INVENTION

In order to solve the problems described above, the present disclosure adopts the following aspects.
(1) A head chip according to an aspect of the present disclosure includes a flow channel member in which a plurality of pressure chambers penetrating in a first direction is arranged in a second direction crossing the first direction, a first member which includes an actuator plate deformable in the first direction, and which is bonded on the flow channel member in a state of closing the pressure chambers from a first side in the first direction, and a second member which includes a jet hole plate provided with jet holes communicated with the pressure chambers, and which is bonded on the flow channel member in a state of closing the pressure chambers from a second side as an opposite side to the first side in the first direction, wherein the flow channel member includes a partition wall configured to partition the pressure chambers adjacent to each other, and a bonding area between the partition wall and the second member is larger than a bonding area between the partition wall and the first member.

According to the present aspect, it is possible to ensure the rigidity of the partition wall while ensuring the volume of the pressure chamber compared to when making the bonding area between the partition wall and the second member equivalent to the bonding area between the partition wall and the first member. Thus, it is possible to prevent the deformation of the partition wall when the pressure inside the pressure chamber changes due to the deformation of the actuator plate, and therefore, it is possible to effectively transfer the elastic energy to the liquid located inside the pressure chamber. As a result, it is possible to increase the pressure to be generated by the pressure chamber.
(2) In the head chip according to the aspect (1) described above, it is preferable that a portion of the partition wall, the portion partitioning the pressure chambers adjacent to each other in the second direction, is formed to have a stepped shape in which the closer to the first side in the first direction a part is located, the smaller a dimension in the second direction of that part is.

According to the present aspect, it is possible to obtain the desired pressure to be generated by the pressure chamber while ensuring the volume of the pressure chamber. Further, it is possible to enhance the workability compared to when, for example, forming the partition wall so as to have a taper shape.
(3) In the head chip according to one of the aspects (1) and (2) described above, it is preferable that a common flow channel is formed in a portion of the flow channel member, the portion being located at one side with respect to the pressure chambers in a third direction crossing the second direction when viewed from the first direction, a plurality of communication channels which extend in the third direction, and which are configured to individually couple the common flow channel and the pressure chambers to each other is provided to the partition wall, and a flow channel cross-sectional area perpendicular to the third direction of the communication channel is smaller than a flow channel cross-sectional area perpendicular to the third direction of the pressure chamber.

According to the present aspect, it is possible to make the distance between the communication channels adjacent to each other longer compared to the distance between the pressure chambers adjacent to each other. Thus, it is possible to ensure the distance between the pressure chambers through the common flow channel in the pressure chambers adjacent to each other. Therefore, it is possible to prevent so-called crosstalk that a pressure variation in one pressure chamber is propagated to other pressure chambers through the common flow channel and the communication channels. Moreover, since the flow channel cross-sectional area of the communication channel is smaller than the flow channel cross-sectional area of the pressure chamber, it is easy to prevent the pressure variation from propagating from the common flow channel to the pressure chambers through the communication channels.
(4) In the head chip according to any of the aspects (1) through (3) described above, it is preferable that the flow channel cross-sectional area perpendicular to the third direction of the pressure chamber gradually increases as getting away from the communication channel in the third direction.

According to the present aspect, it is possible to make the liquid flowing into the pressure chamber from the communication channel smoothly circulate in the pressure chamber.
(5) In the head chip according to any of the aspects (1) through (4) described above, it is preferable that the flow channel member includes a coupling part configured to couple portions of the partition wall to each other, the portions facing each other in a direction crossing the first direction, the coupling part facing the pressure chamber, and being located at a position failing to overlap the jet hole when viewed from the first direction.

According to the present aspect, since the portions of the partition wall, the portions being opposed to each other, are coupled to each other by the coupling part, it is possible to increase the rigidity of the partition wall. As a result, it is possible to prevent the deformation of the partition wall when the pressure inside the pressure chamber changes due to the deformation of the actuator plate, and therefore, it is possible to effectively transfer the elastic energy to the liquid located inside the pressure chamber. Therefore, it is possible to increase the pressure to be generated by the pressure chamber.

Moreover, since the portions opposed to each other of the partition wall are not separated from each other when processing the lower surface of the flow channel member to make the pressure chambers penetrate, it is possible to achieve the increase in manufacturing efficiency and yield ratio.
(6) In the head chip according to any of the aspects (1) through (5) described above, it is preferable that a polarization direction of the actuator plate is set in the first direction, and the actuator plate includes a first electrode formed on a first surface of the actuator plate, the first surface facing to the first side in the first direction, a first opposed electrode which is formed on a second surface of the actuator plate so as to be opposed to the first electrode, the second surface facing to the second side in the first direction, and which is configured to generate a potential difference from the first electrode, and a second electrode which is formed on the second surface of the actuator plate so as to be adjacent to the first opposed electrode, and which is configured to generate a potential difference from the first opposed electrode.

According to the present aspect, by generating the potential difference between the first electrode and the second electrode, it is possible to generate an electric field in a direction crossing a polarization direction of the actuator plate. Thus, by deforming the actuator plate in the first direction in the shear mode (a roof-shoot type), it is possible to change the volume of the pressure chamber. Further, by generating the potential difference between the first electrode and the first opposed electrode, it is possible to generate an electric field also in the polarization direction of the actuator plate. Thus, by deforming the actuator plate in the first direction in the bend mode (a bimorph type), it is possible to change the volume of the pressure chamber. In other words, by deforming the actuator plate in the first direction in both of the shear mode and the bend mode, it is possible to increase the pressure to be generated in the pressure chamber when ejecting the liquid.
(7) In the head chip according to any of the aspects (1) through (6) described above, it is preferable that the jet hole plate is made of metal.

According to the present aspect, since it becomes easy to ensure the rigidity of the jet hole plate, it becomes difficult for the jet hole plate to deform when the pressure in the pressure chamber varies due to the deformation of the actuator plate. Therefore, the deformation of the actuator plate becomes easy to propagate to the liquid, and thus, it is easy to obtain the desired pressure to be generated in the pressure chamber.
(8) In the head chip according to any of the aspects (1) through (7) described above, it is preferable that the jet hole plate is directly bonded to the flow channel member.

According to the present aspect, it is possible to form the second member from a single member of the jet hole plate. Thus, it is possible to simplify the bonding step of the second member to the flow channel member, and thus, it is possible to achieve a reduction in cost and an increase in yield ratio. Further, by simplifying the bonding step, after assembling the head chip, it is possible to prevent an occurrence of a failure of the head chip due to a bonding part.
(9) A liquid jet head according to the present disclosure includes the head chip according to any one of the aspects (1) through (8) described above.

According to the present aspect, since the head chip according to the aspect described above is provided, it is possible to provide the liquid jet head which is capable of exerting the desired jet performance, and which is high in quality.
(10) A liquid jet recording device according to an aspect of the present disclosure includes the liquid jet head according to the aspect (8) described above.

According to the present aspect, since the liquid jet head according to the aspect described above is provided, it is possible to provide the liquid jet recording device which is capable of exerting the desired jet performance, and which is high in quality.

According to an aspect of the present disclosure, it is possible to effectively transfer the elastic energy to the ink in the pressure chamber to increase the pressure to be generated by the pressure chamber.

### BRIEF DESCRIPTION OF THE DRAWINGS

FIG. 1 is a schematic configuration diagram of an inkjet printer according to a first embodiment.

FIG. 2 is a schematic configuration diagram of an inkjet head and an ink circulation mechanism according to the first embodiment.

FIG. 3 is an exploded perspective view of a head chip according to the first embodiment.

FIG. 4 is a cross-sectional view of the head chip corresponding to the line IV-IV shown in FIG. 3.

FIG. 5 is a cross-sectional view of the head chip corresponding to the line V-V shown in FIG. 4.

FIG. 6 is a plan view of a flow channel member related to the first embodiment.

FIG. 7 is an enlarged perspective view of the flow channel member related to the first embodiment.

FIG. 8 is a bottom view of an actuator plate related to the first embodiment.

FIG. 9 is a plan view of the actuator plate related to the first embodiment.

FIG. 10 is a plan view of a cover plate related to the first embodiment.

FIG. 11 is an explanatory diagram for explaining a behavior of deformation when ejecting ink regarding the head chip according to the first embodiment.

FIG. 12 is a flowchart for explaining a method of manufacturing the head chip according to the first embodiment.

FIG. 13 is a process chart for explaining the method of manufacturing the head chip according to the first embodiment, and is a cross-sectional view corresponding to FIG. 5.

FIG. 14 is a process chart for explaining the method of manufacturing the head chip according to the first embodiment, and is a cross-sectional view corresponding to FIG. 4.

FIG. 15 is a process chart for explaining the method of manufacturing the head chip according to the first embodiment, and is a cross-sectional view corresponding to FIG. 5.

FIG. 16 is a process chart for explaining the method of manufacturing the head chip according to the first embodiment, and is a cross-sectional view corresponding to FIG. 5.

FIG. 17 is a process chart for explaining the method of manufacturing the head chip according to the first embodiment, and is a cross-sectional view corresponding to FIG. 4.

FIG. 18 is a process chart for explaining the method of manufacturing the head chip according to the first embodiment, and is a cross-sectional view corresponding to FIG. 4.

FIG. 19 is a process chart for explaining the method of manufacturing the head chip according to the first embodiment, and is a cross-sectional view corresponding to FIG. 4.

FIG. 20 is a process chart for explaining the method of manufacturing the head chip according to the first embodiment, and is a cross-sectional view corresponding to FIG. 5.

FIG. 21 is a process chart for explaining the method of manufacturing the head chip according to the first embodiment, and is a cross-sectional view corresponding to FIG. 5.

FIG. 22 is a process chart for explaining the method of manufacturing the head chip according to the first embodiment, and is a cross-sectional view corresponding to FIG. 4.

FIG. 23 is a process chart for explaining the method of manufacturing the head chip according to the first embodiment, and is a cross-sectional view corresponding to FIG. 4.

FIG. 24 is a process chart for explaining the method of manufacturing the head chip according to the first embodiment, and is a cross-sectional view corresponding to FIG. 4.

FIG. 25 is a cross-sectional view corresponding to FIG. 4 in a head chip according to a second embodiment.

FIG. 26 is a cross-sectional view corresponding to FIG. 5 in the head chip according to the second embodiment.

FIG. 27 is a perspective view corresponding to FIG. 7 in the head chip according to the second embodiment.

FIG. 28 is a cross-sectional view corresponding to FIG. 4 in a head chip according to a third embodiment.

FIG. 29 is a cross-sectional view corresponding to FIG. 5 in the head chip according to the third embodiment.

FIG. 30 is a perspective view corresponding to FIG. 7 in the head chip according to the third embodiment.

FIG. 31 is a cross-sectional view corresponding to FIG. 4 in a head chip according to a fourth embodiment.

FIG. 32 is a cross-sectional view corresponding to FIG. 5 in the head chip according to the fourth embodiment.

FIG. 33 is a perspective view corresponding to FIG. 7 in the head chip according to the fourth embodiment.

### DETAILED DESCRIPTION OF THE PREFERRED EMBODIMENTS

Some embodiments according to the present disclosure will hereinafter be described with reference to the drawings. In the embodiments and modified examples hereinafter described, constituents corresponding to each other are denoted by the same reference symbols, and the description thereof will be omitted in some cases. In the following description, expressions representing relative or absolute arrangements such as “parallel,” “perpendicular,” “central,” and “coaxial” not only represent strictly such arrangements, but also represent the state of being relatively displaced with a tolerance, or an angle or a distance to the extent that the same function can be obtained. In the following embodiment, the description will be presented citing an inkjet printer (hereinafter simply referred to as a printer) for performing recording on a recording target medium using ink (a liquid) as an example. The scale size of each member is arbitrarily modified so as to provide a recognizable size to the member in the drawings used in the following description.

### First Embodiment

### [Printer 1]

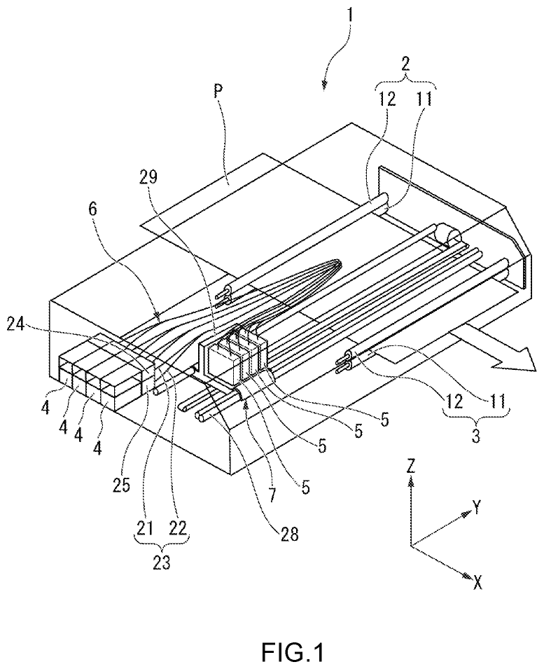

FIG. 1 is a schematic configuration diagram of a printer 1.

The printer (a liquid jet recording device) 1 shown in FIG. 1 is provided with a pair of conveying mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, an X direction coincides with a conveying direction (a sub-scanning direction) of a recording target medium P (e.g., paper). A Y direction coincides with a scanning direction (a main scanning direction) of the scanning mechanism 7. A Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the present specification, the +Z side corresponds to an upper side in the gravitational direction, and the −Z side corresponds to a lower side in the gravitational direction.

The conveying mechanisms 2, 3 convey the recording target medium P toward the +X side. The conveying mechanisms 2, 3 each include a pair of rollers 11, 12 extending in, for example, the Y direction.

The ink tanks 4 respectively contain four colors of ink such as yellow ink, magenta ink, cyan ink, and black ink. The inkjet heads 5 are configured so as to be able to respectively eject the four colors of ink, namely the yellow ink, the magenta ink, the cyan ink, and the black ink according to the ink tanks 4 coupled thereto.

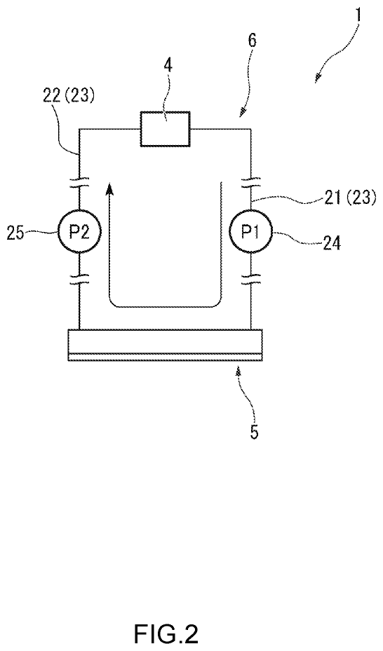

FIG. 2 is a schematic configuration diagram of the inkjet head 5 and the ink circulation mechanism 6.

As shown in FIG. 1 and FIG. 2, the ink circulation mechanism 6 circulates the ink between the ink tank 4 and the inkjet head 5. Specifically, the ink circulation mechanism 6 is provided with a circulation flow channel 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 is provided with positive pressure with respect to the ink jet head 5.

The suction pump 25 depressurizes the inside of the ink discharge tube 22 to suck the ink from the inkjet head 5 through the ink discharge tube 22. Thus, the ink discharge tube 22 is provided with negative pressure with respect to the ink jet head 5. It is arranged that the ink can circulate between the inkjet head 5 and the ink tank 4 through the circulation flow channel 23 by driving the pressure pump 24 and the suction pump 25.

As shown in FIG. 1, the scanning mechanism 7 reciprocates the inkjet heads 5 in the Y direction. The scanning mechanism 7 is provided with a guide rail 28 extending in the Y direction, and a carriage 29 movably supported by the guide rail 28.

### <Inkjet Heads 5>

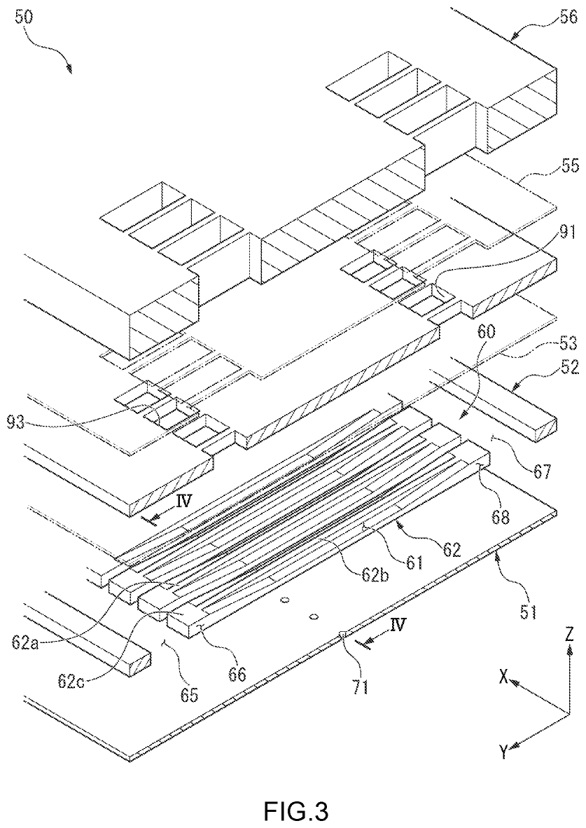

The inkjet heads 5 are mounted on the carriage 29. In the illustrated example, the plurality of inkjet heads 5 is mounted on the single carriage 29 so as to be arranged side by side in the Y direction. The inkjet heads 5 are each provided with a head chip 50 (see FIG. 3), an ink supply section (not shown) for coupling the ink circulation mechanism 6 and the head chip 50, and a control section (not shown) for applying a drive voltage to the head chip 50.

### <Head Chip 50>

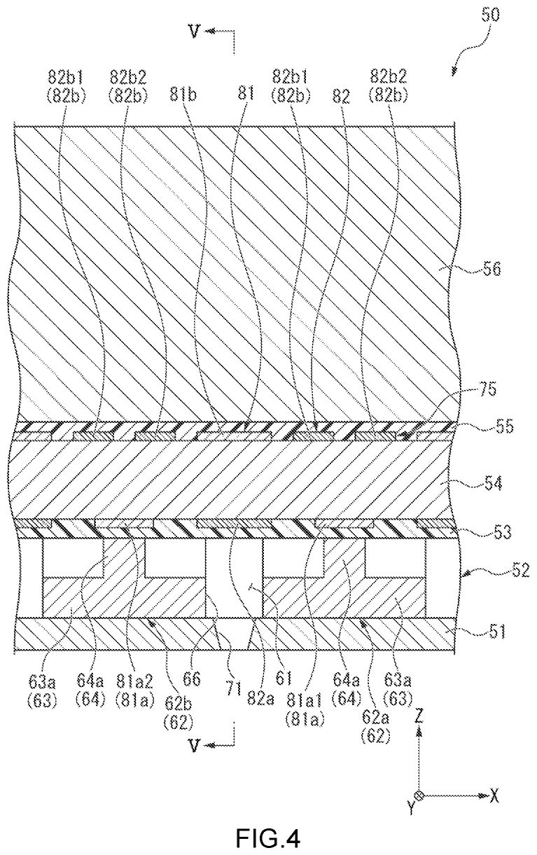

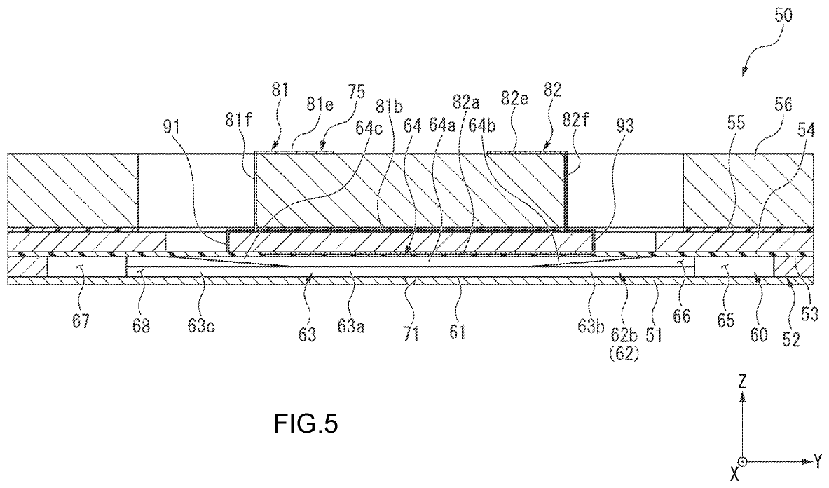

FIG. 3 is an exploded perspective view of the head chip 50. FIG. 4 is a cross-sectional view of the head chip 50 corresponding to the line IV-IV shown in FIG. 3. FIG. 5 is a cross-sectional view of the head chip 50 corresponding to the line V-V shown in FIG. 3.

The head chip 50 shown in FIG. 3 through FIG. 5 is a so-called recirculating side-shoot type head chip 50 which circulates the ink with the ink tank 4, and at the same time, ejects the ink from a central portion in the extending direction (the Y direction) in a pressure chamber 61 described later. The head chip 50 is provided with a nozzle plate 51, a flow channel member 52, a first film 53, an actuator plate 54, a second film 55, and a cover plate 56. In the following explanation, the description is presented in some cases defining a direction (+Z side) from the nozzle plate 51 toward the cover plate 56 along the Z direction as an upper side, and a direction (−Z side) from the cover plate 56 toward the nozzle plate 51 along the Z direction as a lower side.

The flow channel member 52 is shaped like a plate with the thickness direction set to the Z direction. The flow channel member 52 is formed of a material having ink resistance. As such a material, it is possible to adopt, for example, metal, metal oxide, glass, resin, and ceramics. The flow channel member 52 is provided with a flow channel 60 through which the ink circulates, and a plurality of pressure chambers 61 which is communicated with the flow channel 60, and which contains the ink.

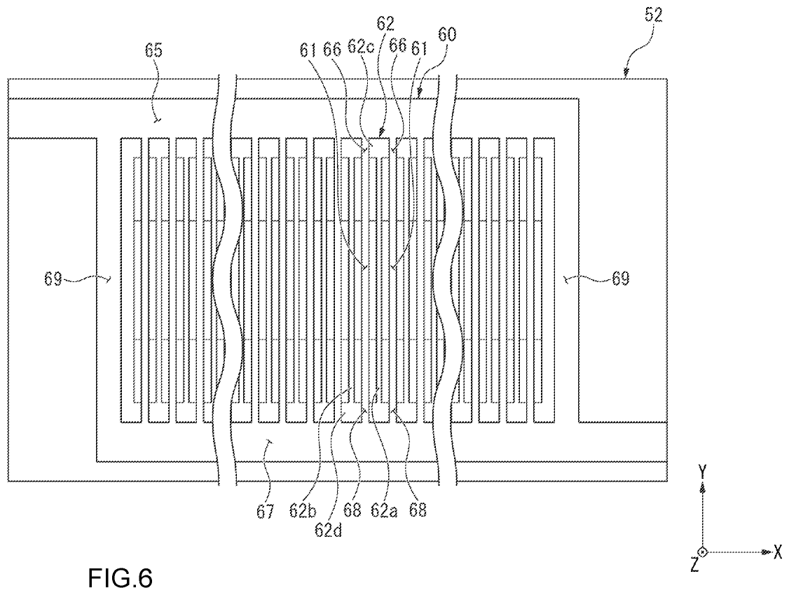

FIG. 6 is a plan view of the flow channel member 52.

As shown in FIG. 6, the pressure chambers 61 are arranged side by side at intervals in the X direction. The pressure chambers 61 are each formed like a groove linearly extending in the Y direction. The pressure chambers 61 each penetrate the flow channel member 52 throughout the entire length in the Y direction. It should be noted that it is possible for the pressure chamber 61 to penetrate the flow channel member 52 in a part in the Y direction. It should be noted that the configuration in which the channel extension direction coincides with the Y direction will be described in the first embodiment, but the channel extension direction can cross the Y direction. Further, a planar shape of the pressure chamber 61 is not limited to a rectangular shape (a shape the longitudinal direction of which is set to either one of the X direction and the Y direction, and the short-side direction of which is set to the other thereof). The planar shape of the pressure chamber 61 can be a polygonal shape such as a square shape or a triangular shape, a circular shape, an elliptical shape, or the like.

In the plan view, the pressure chambers 61 adjacent in the X direction to each other are partitioned from each other by the partition wall 62. The partition wall 62 surrounds the periphery of the pressure chamber 61 in the plan view. Specifically, the partition wall 62 is provided with a +X-side side wall 62a located at the +X side with respect to the pressure chamber 61, a −X-side side wall 62b located at the −X side with respect to the pressure chamber 61, a +Y-side end wall 62c located at the +Y side with respect to the pressure chamber 61, and a −Y-side end wall 62d located at the −Y side with respect to the pressure chamber 61.

The side walls 62a, 62b are each a portion of the flow channel member 52, the portion being located between the pressure chambers 61 adjacent to each other, and each partition the pressure chambers 61 adjacent to each other in the X direction. In the first embodiment, the +X-side side wall 62a corresponding to one pressure chamber 61 is also used as the −X-side side wall 62b corresponding to another pressure chamber 61 adjacent at the +X side to the one pressure chamber 61. Further, the −X-side side wall 62b corresponding to one pressure chamber 61 is also used as the +X-side side wall 62a corresponding to another pressure chamber 61 adjacent at the −X side to the one pressure chamber 61. Further, the side walls 62a, 62b all have substantially the same configurations. Therefore, in the following explanation, the description will be presented citing the +X-side side wall 62a out of the side walls 62a, 62b as an example.

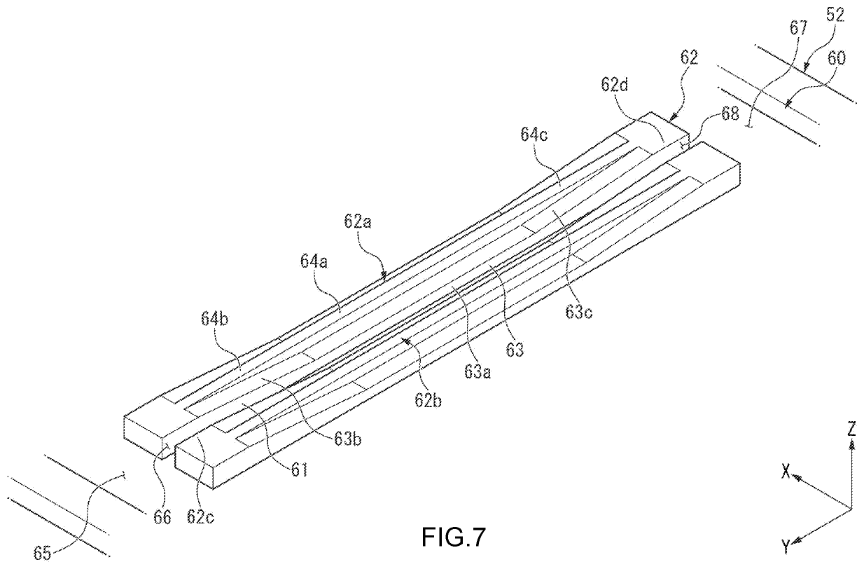

FIG. 7 is an enlarged perspective view of the flow channel member 52.

As shown in FIG. 4, FIG. 5, and FIG. 7, the +X-side side wall 62a is formed to have a stepped shape in which the higher a part is located, the narrower the width in the X direction of the part is when viewed from the Y direction. The +X-side side wall 62a is provided with a wide part 63 and a narrow part 64.

The wide part 63 constitutes a lower part of the +X-side side wall 62a. The wide part 63 is formed so that the width in the X direction is uniform in the Y direction and the Z direction. It should be noted that it is possible for the wide part 63 to be different in width in the X direction in accordance with a position in the Y direction or the Z direction.

The wide part 63 is provided with a central wide part 63a located in a central portion in the Y direction in the wide part 63, a +Y-side wide part 63b connected toward the +Y side with respect to the central wide part 63a, and a −Y-side wide part 63c connected toward the −Y side with respect to the central wide part 63a.

The central wide part 63a is formed so that the height in the Z direction is uniform in the Y direction. In other words, upper and lower surfaces of the central wide part 63a are arranged along the X-Y plane. It should be noted that the height of the central wide part 63a with respect to the depth of the pressure chamber 61 can arbitrarily be changed.

In the +Y-side wide part 63b, the height in the Z direction gradually increases in a direction toward the +Y side. Specifically, a lower surface of the +Y-side wide part 63b is arranged coplanar with the lower surface of the central wide part 63a. An upper surface of the +Y-side wide part 63b is formed to have a curved surface (a tilted surface) extending upward in a direction toward the +Y side. A maximum height (a height in the +Y-side end edge) of the +Y-side wide part 63b is made equivalent to the height of the +Y-side end wall 62c. It should be noted that the maximum height of the +Y-side wide part 63b can be lower than the +Y-side end wall 62c. The length in the Y direction in the +Y-side wide part 63b is longer than the length of the central wide part 63a.

The −Y-side wide part 63c is formed to be symmetric with respect to the +Y-side wide part 63b when viewed from the X direction. Specifically, in the −Y-side wide part 63c, the height in the Z direction gradually increases in a direction toward the −Y side. Specifically, a lower surface of the −Y-side wide part 63c is arranged coplanar with the lower surface of the central wide part 63a. An upper surface of the −Y-side wide part 63c is formed to have a curved surface (a tilted surface) extending upward in a direction toward the +Y side. A maximum height (a height in the −Y-side end edge) of the −Y-side wide part 63c is made equivalent to the height of the −Y-side end wall 62d. It should be noted that the maximum height of the −Y-side wide part 63c can be lower than the −Y-side end wall 62d. It should be noted that the +Y-side wide part 63b and the −Y-side wide part 63c can be different from each other.

The narrow part 64 protrudes upward from a central portion in the X direction in the wide part 63. The narrow part 64 is formed so that the width in the X direction is uniform in the Y direction. It should be noted that it is possible to make the width of the narrow part 64 different in accordance with the position in the Y direction.

The narrow part 64 is provided with a central narrow part 64a located in a central portion in the Y direction in the narrow part 64, a +Y-side narrow part 64b connected toward the +Y side with respect to the central narrow part 64a, and a −Y-side narrow part 64c connected toward the −Y side with respect to the central narrow part 64a.

The central narrow part 64a protrudes upward from a central portion in the X direction in the central wide part 63a. The central narrow part 64a is formed so that the height in the Z direction is uniform in the Y direction. In other words, upper and lower surfaces of the central narrow part 64a are arranged along the X-Y plane.

The +Y-side narrow part 64b protrudes upward from a central portion in the X direction in the +Y-side wide part 63b. An upper surface of the +Y-side narrow part 64b is arranged coplanar with an upper surface of the central narrow part 64a. Therefore, in the +Y-side narrow part 64b, the height in the Z direction gradually decreases in a direction toward the +Y side.

The −Y-side narrow part 64c protrudes upward from a central portion in the X direction in the −Y-side wide part 63c. An upper surface of the −Y-side narrow part 64c is arranged coplanar with the upper surface of the central narrow part 64a. Therefore, in the −Y-side narrow part 64c, the height in the Z direction gradually decreases in a direction toward the −Y side.

The flow channel cross-sectional area perpendicular to the Y direction in the pressure chamber 61 gradually increases in a direction from both end portions toward the central portion in the Y direction. Specifically, in a region of the +Y-side narrow part 64b and the +Y-side narrow part 64b out of the inside of the pressure chamber 61, the flow channel cross-sectional area increases in a direction toward the inside in the Y direction. In a region of the −Y-side wide part 63c and the −Y-side narrow part 64c out of the inside of the pressure chamber 61, the flow channel cross-sectional area increases in a direction toward the inside in the Y direction. On the other hand, in a region of the central wide part 63a and the central narrow part 64a out of the inside of the pressure chamber 61, the flow channel cross-sectional area is made uniform.

As shown in FIG. 3, FIG. 5, and FIG. 7, the +Y-side end wall 62c bridges between the +Y-side end portions of the side walls 62a, 62b forming one pressure chamber 61. The lower surface of the +Y-side end wall 62c is arranged coplanar with the lower surfaces of the side walls 62a, 62b (the wide part 63). The upper surface of the +Y-side end wall 62c is arranged coplanar with the upper surfaces of the side walls 62a, 62b (the narrow part 64).

The −Y-side end wall 62d bridges between the −Y-side end portions of the side walls 62a, 62b forming one pressure chamber 61. The lower surface of the −Y-side end wall 62d is arranged coplanar with the lower surfaces of the side walls 62a, 62b (the wide part 63). The upper surface of the −Y-side end wall 62d is arranged coplanar with the upper surfaces of the side walls 62a, 62b (the narrow part 64).

As shown in FIG. 3 and FIG. 6, the flow channel 60 includes an entrance-side common flow channel 65, entrance-side communication channels 66, an exit-side common flow channel 67, exit-side communication channels 68, and bypass channels 69.

The entrance-side common flow channel 65 extends in the X direction in a portion of the flow channel member 52, the portion being located at the +Y side of the pressure chambers 61. The entrance-side common flow channel 65 and each of the pressure chambers 61 are partitioned by the +Y-side end wall 62c of that pressure chamber 61. A −X-side end portion in the entrance-side common flow channel 65 is coupled to an entrance port (not shown). The entrance port is directly or indirectly coupled to the ink supply tube 21 (see FIG. 2). In other words, the ink flowing through the ink supply tube 21 is supplied to the entrance-side common flow channel 65 through the entrance port.

The entrance-side communication channels 66 are each branched toward the −Y side from a portion of the entrance-side common flow channel 65, the portion overlapping each of the pressure chambers 61 when viewed from the X direction to thereby connect the entrance-side common flow channel 65 and that pressure chamber 61 to each other. Specifically, each of the entrance-side communication channels 66 penetrates the +Y-side end wall 62c of corresponding one of the pressure chambers 61 in the Y direction and the Z direction. Each of the entrance-side communication channels 66 is formed in a central portion in the X direction in corresponding one of the +Y-side end walls 62c with a uniform depth throughout the entire length in the Y direction. In other words, the flow channel cross-sectional area perpendicular to the Y direction in each of the entrance-side communication channels 66 is uniform throughout the entire length in the Y direction.

The width in the X direction in the entrance-side communication channel 66 is equivalent to a distance between the wide parts 63 adjacent to each other, and is made smaller than a distance between the narrow parts 64 adjacent to each other. Therefore, the flow channel cross-sectional area of the entrance-side communication channel 66 is made smaller than the maximum flow channel cross-sectional area of the pressure chamber 61.

The exit-side common flow channel 67 extends in the X direction in a portion of the flow channel member 52, the portion being located at the −Y side with respect to each of the pressure chambers 61. The exit-side common flow channel 67 and each of the pressure chambers 61 are partitioned by the −Y-side end wall 62d of that pressure chamber 61. A +X-side end portion in the exit-side common flow channel 67 is coupled to an exit port (not shown). The exit port is directly or indirectly coupled to the ink discharge tube 22 (see FIG. 2). In other words, the ink flowing through the exit-side common flow channel 67 is supplied to the ink discharge tube 22 through the exit port.

The exit-side communication channels 68 are each branched toward the +Y side from a portion of the exit-side common flow channel 67, the portion overlapping each of the pressure chambers 61 when viewed from the X direction to thereby connect the exit-side common flow channel 67 and that pressure chamber 61 to each other. Specifically, each of the exit-side communication channels 68 penetrates the −Y-side end wall 62d of corresponding one of the pressure chambers 61 in the Y direction and the Z direction. In the first embodiment, each of the exit-side communication channels 68 is formed in a central portion in the X direction in corresponding one of the −Y-side end walls 62d with a uniform depth throughout the entire length in the Y direction. In other words, the flow channel cross-sectional area perpendicular to the Y direction in each of the exit-side communication channels 68 is uniform throughout the entire length in the Y direction.

The width in the X direction in the exit-side communication channel 68 is equivalent to the distance between the wide parts 63 adjacent to each other, and is made smaller than the distance between the narrow parts 64 adjacent to each other. Therefore, the flow channel cross-sectional area of the exit-side communication channel 68 is made smaller than the maximum flow channel cross-sectional area of the pressure chamber 61. It should be noted that the dimensions of the pressure chambers 61 and the communication channels 66, 68 can arbitrarily be changed.

The bypass channels 69 couple +X-side end portions of the entrance-side common flow channel 65 and the exit-side common flow channel 67 to each other, and −X-side end portions of the entrance-side common flow channel 65 and the exit-side common flow channel 67 to each other, respectively.

As shown in FIG. 4 and FIG. 5, the nozzle plate 51 is fixed to the lower surface of the flow channel member 52 with bonding or the like. In other words, the nozzle plate 51 is bonded to a portion of the flow channel member 52, the portion including a lower surface of the partition wall 62 (the wide part 63 and the end walls 62c, 62d). The nozzle plate 51 closes a lower end opening part of each of the flow channel 60 and the pressure chambers 61. In the first embodiment, the nozzle plate 51 is formed of a metal material such as SUS or Ni—Pd. It should be noted that it is possible for the nozzle plate 51 to have a single layer structure or a laminate structure with a resin material (e.g., polyimide), glass, silicone, or the like besides the metal material.

The nozzle plate 51 is provided with a plurality of nozzle holes 71 penetrating the nozzle plate 51 in the Z direction. The nozzle holes 71 are arranged at intervals in the X direction. The nozzle holes 71 are each communicated with corresponding one of the pressure chambers 61 in a central portion in the X direction and the Y direction. In the first embodiment, each of the nozzle holes 71 is formed to have, for example, a taper shape having an inner diameter gradually decreasing along a direction from the upper side toward the lower side. In the first embodiment, there is described the configuration in which the plurality of pressure chambers 61 and the plurality of nozzle holes 71 are aligned in the X direction, but this configuration is not a limitation. Defining the plurality of pressure chambers 61 and the plurality of nozzle holes 71 arranged in the X direction as a nozzle array, it is possible to dispose two or more nozzle arrays at intervals in the Y direction.

The first film 53 is fixed to an upper surface of the flow channel member 52 with bonding or the like. The first film 53 is arranged throughout the entire area of the upper surface of the flow channel member 52. In other words, the first film 53 is bonded to a portion of the flow channel member 52, the portion including an upper surface of the partition wall 62 (the narrow part 64 and the end walls 62c, 62d). As described above, in the flow channel member 52, the lower surface including the wide part 63 is bonded to the nozzle plate 51 on the one hand, and the upper surface including the narrow part 64 is bonded to the first film 53 on the other hand. Therefore, the bonding area between the partition wall 62 and the nozzle plate 51 is made larger than the bonding area between the partition wall 62 and the first film 53.

The first film 53 closes an upper end opening part of each of the flow channel 60 and the pressure chambers 61. The first film 53 is formed of an elastically deformable material having an insulating property and ink resistance. As such a material, the first film 53 is formed of, for example, a resin material (a polyimide type, an epoxy type, a polypropylene type, and so on).

The actuator plate 54 is fixed to an upper surface of the first film 53 with bonding or the like with the thickness direction set to the Z direction. The actuator plate 54 is opposed to the pressure chambers 61 in the Z direction across the first film 53. It should be noted that the actuator plate 54 is not limited to the configuration of covering the pressure chambers 61 in a lump, but can individually be disposed for each of the pressure chambers 61.

The actuator plate 54 is formed of a piezoelectric material such as PZT (lead zirconate titanate). The actuator plate 54 is set so that the polarization direction faces to one direction toward the +Z side. On both surfaces of the actuator plate 54, there are formed drive interconnections 75. The actuator plate 54 is configured so as to be able to be deformed in the Z direction by an electric field being generated by a voltage applied by the drive interconnections 75. The actuator plate 54 expands or contracts the volume in the pressure chamber 61 due to the deformation in the Z direction to thereby eject the ink from the inside of the pressure chamber 61. It should be noted that the configuration of the drive interconnections 75 will be described later.

The second film 55 is fixed to an upper surface of the actuator plate 54 with bonding or the like. In the first embodiment, the second film 55 covers the entire area of the upper surface of the actuator plate 54. The second film 55 is formed of an elastically deformable material having an insulating property. As such a material, it is possible to adopt substantially the same material as that of the first film 53. It should be noted that the second film 55 is not an essential constituent. It is possible for the actuator plate 54 and the cover plate 56 to be bonded to each other via an adhesive layer including, for example, an epoxy adhesive or an acrylic adhesive.

The cover plate 56 is fixed to an upper surface of the second film 55 with bonding or the like with the thickness direction set to the Z direction. The cover plate 56 is thicker in thickness in the Z direction than the actuator plate 54, the flow channel member 52, and the films 53, 55. In the first embodiment, the cover plate 56 is formed of a material (e.g., metal oxide, glass, resin, or ceramics) having an insulating property.

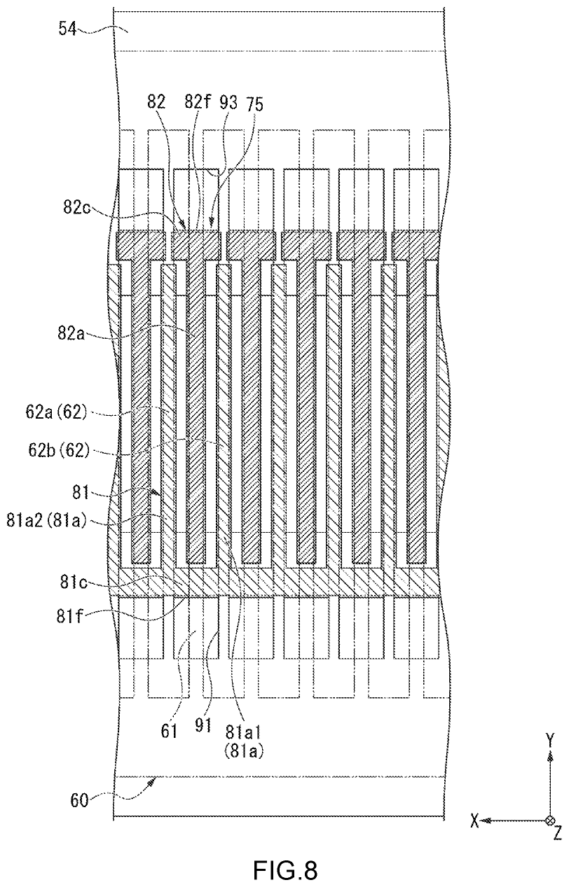

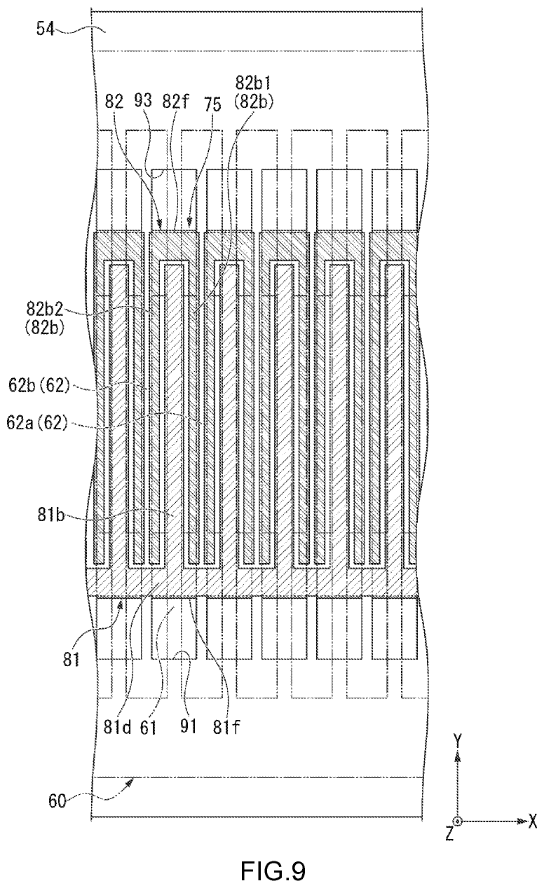

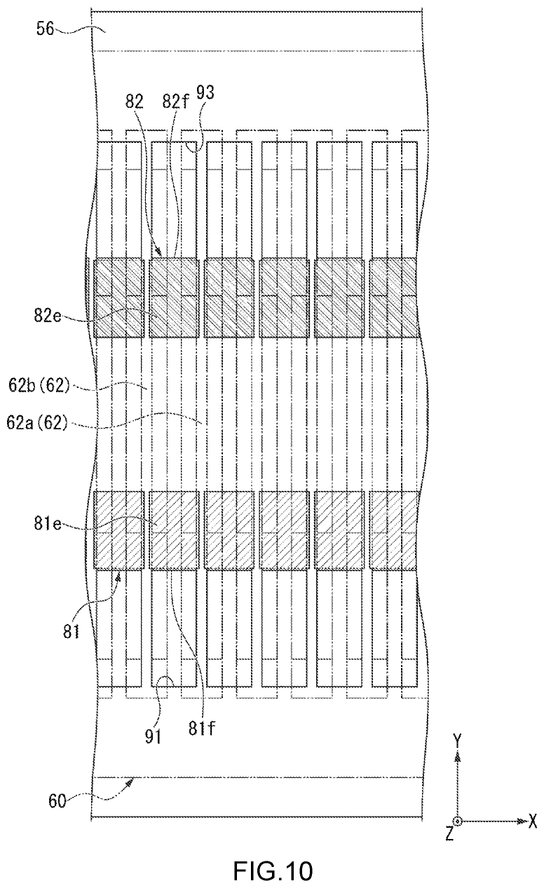

Subsequently, a structure of the drive interconnections 75 will be described. FIG. 8 is a bottom view of the actuator plate 54. FIG. 9 is a plan view of the actuator plate 54. FIG. 10 is a plan view of the cover plate 56. The drive interconnections 75 are disposed so as to correspond to the pressure chambers 61. The drive interconnections 75 corresponding to the pressure chambers 61 adjacent to each other have respective configurations substantially the same as each other. In the following explanation, the drive interconnections 75 disposed so as to correspond to one pressure chamber 61 out of the plurality of pressure chambers 61 are described as an example, and the description of the drive interconnections 75 corresponding to the other pressure chambers 61 will arbitrarily be omitted.

As shown in FIG. 8 and FIG. 9, the drive interconnections 75 consist of a common interconnection 81 and an individual interconnection 82.

The common interconnection 81 is provided with a first common electrode 81a, second common electrodes 81b, a lower-surface patterned interconnection 81c, an upper-surface patterned interconnection 81d, a common pad 81e, and a through interconnection 81f.

As shown in FIG. 4 and FIG. 8, the first common electrodes 81a are formed at positions overlapping the respective side walls 62a, 62b when viewed from the Z direction on a lower surface of the actuator plate 54. Specifically, in the first common electrodes 81a, the whole of the first common electrode 81a (hereinafter referred to as a +X-side common electrode 81a1) located at the +X side overlaps the side wall 62a (at least the narrow part 64) when viewed from the Z direction. In contrast, in the first common electrodes 81a, the whole of the first common electrode 81a (hereinafter referred to as a −X-side common electrode 81a2) located at the −X side overlaps the side wall 62b (at least the narrow part 64) when viewed from the Z direction. The first common electrodes 81a linearly extend in the Y direction with a length equivalent to the length of the pressure chamber 61. In the first embodiment, the +X-side common electrode 81al corresponding to one pressure chamber 61 is also used as the −X-side common electrode 81a2 of another pressure chamber 61 adjacent at the +X side to the one pressure chamber 61. In contrast, the −X-side common electrode 81a2 corresponding to one pressure chamber 61 is also used as the +X-side common electrode 81al of another pressure chamber 61 adjacent at the −X side to the one pressure chamber 61. It should be noted that between the pressure chambers 61, the common electrodes 81a1, 81a2 can be separated from each other.

As shown in FIG. 4 and FIG. 9, the second common electrode 81b is arranged at a position which overlaps corresponding one of the pressure chambers 61 when viewed from the Z direction, and which fails to overlap the first common electrode 81a when viewed from the Z direction on the upper surface of the actuator plate 54. In the illustrated example, the second common electrode 81b is formed in a region including a central portion in the X direction in the pressure chamber 61. The second common electrode 81b linearly extends in the Y direction with a length equivalent to the length of the pressure chamber 61.

As shown in FIG. 4 and FIG. 8, the lower-surface patterned interconnection 81c is coupled to the first common electrodes 81a in a lump on the lower surface of the actuator plate 54. The lower-surface patterned interconnection 81c extends in the X direction in a state of being coupled to the −Y-side end portion in each of the first common electrodes 81a.

As shown in FIG. 4 and FIG. 9, the upper-surface patterned interconnection 81d is coupled to the second common electrode 81b on the upper surface of the actuator plate 54. The upper-surface patterned interconnection 81d extends in the X direction in a state of being coupled to the −Y-side end portion in the second common electrodes 81b.

As shown in FIG. 10, the common pad 81e is formed on the upper surface of the cover plate 56. The common pad 81e extends in the Y direction on a portion of the upper surface of the cover plate 56, the portion overlapping the pressure chamber 61 when viewed from the Z direction.

The through interconnection 81f connects the lower-surface patterned interconnection 81c, the upper-surface patterned interconnection 81d and the common pad 81e to each other. The through interconnection 81f is disposed so as to penetrate the actuator plate 54, the second film 55, and the cover plate 56 in the Z direction. Specifically, a common interconnecting hole 91 is formed in a portion of the actuator plate 54, the second film 55, and the cover plate 56, the portion being located at the −Y side with respect to the patterned interconnections 81c, 81d. The common interconnecting hole 91 is individually formed for each of the pressure chambers 61. A −Y-side end edge in each of the lower-surface patterned interconnection 81c, the upper-surface patterned interconnection 81d, and the common pad 81e is coupled to the through interconnection 81f in an opening edge of the common interconnecting hole 91. It should be noted that the through interconnection 81f and the common interconnecting hole 91 can be disposed in a lump to the pressure chambers 61. In this case, the common interconnecting hole 91 extends in the X direction with the length sufficient to straddle the pressure chambers 61.

As shown in FIG. 8 and FIG. 9, the individual interconnection 82 is provided with a first individual electrode 82a, a second individual electrode 82b, a lower-surface patterned interconnection 82c, an upper-surface patterned interconnection 82d, an individual pad 82e, and a through interconnection 82f.

As shown in FIG. 4 and FIG. 8, the first individual electrode 82a generates a potential difference from the first common electrode 81a, and at the same time, generates a potential difference from the second common electrode 81b. At least a part of the first individual electrode 82a overlaps the second common electrode 81b when viewed from the Z direction. The first individual electrode 82a is formed between the first common electrodes 81a on the lower surface of the actuator plate 54. The first individual electrode 82a extends in the Y direction in a state at a distance in the X direction from each of the first common electrodes 81a.

As shown in FIG. 4 and FIG. 9, the second individual electrode 82b generates a potential difference from the second common electrode 81b, and at the same time, generates a potential difference from the first common electrode 81a. The second individual electrodes 82b are respectively formed in portions located at both sides in the X direction with respect to the second common electrode 81b on the upper surface of the actuator plate 54. The second individual electrodes 82b each extend in the Y direction in a state at a distance in the X direction from the second common electrode 81b. The width in the X direction in the second individual electrode 82b is narrower than the width in the X direction in the first common electrodes 81a.

As shown in FIG. 4 and FIG. 9, out of the second individual electrodes 82b, the second individual electrode 82b (hereinafter referred to as a +X-side individual electrode 82b1) located at the +X side generates a potential difference from the +X-side common electrode 81a1. A part of the +X-side individual electrode 82b1 overlaps the side wall 62a when viewed from the Z direction. The +X-side individual electrode 82b1 is opposed to the +X-side common electrode 81al in the Z direction on the side wall 62a.

Out of the second individual electrodes 82b, the second individual electrode 82b (hereinafter referred to as a −X-side individual electrode 82b2) located at the −X side generates a potential difference from the −X-side common electrode 81a2. A part of the −X-side individual electrode 82b2 overlaps the side wall 62b when viewed from the Z direction. The −X-side individual electrode 82b2 is opposed to the −X-side common electrode 81a2 in the Z direction on the side wall 62b. It should be noted that between the pressure chambers 61 adjacent to each other, the +X-side individual electrode 82b1 in one pressure chamber 61 and the −X-side individual electrode 82b2 in the other pressure chamber 61 are at a distance in the X direction from each other on the side walls 62a, 62b.

As shown in FIG. 8, the lower-surface patterned interconnection 82c is coupled to the first individual electrode 82a on the lower surface of the actuator plate 54. The lower-surface patterned interconnection 82c extends from the +Y-side end portion in the first individual electrode 82a toward both sides in the X direction. The lower-surface patterned interconnections 82c corresponding to the pressure chambers 61 adjacent to each other are separated from each other.

As shown in FIG. 9, the upper-surface patterned interconnection 82d couples the +Y-side end portions of the respective second individual electrodes 82b to each other on the upper surface of the actuator plate 54.

The individual pads 82e are formed on the upper surface of the cover plate 56. The individual pads 82e each extend in the Y direction on a portion of the upper surface of the cover plate 56, the portion overlapping the pressure chamber 61 when viewed from the Z direction.

As shown in FIG. 5, FIG. 8, and FIG. 9, the through interconnection 82f couples the lower-surface patterned interconnection 82c, the upper-surface patterned interconnection 82d, and the individual pad 82e to each other. The through interconnection 82f is disposed so as to penetrate the actuator plate 54 in the Z direction. Specifically, an individual interconnecting hole 93 is formed in a portion of the actuator plate 54, the second film 55, and the cover plate 56, the portion being located at the +Y side with respect to the first individual electrode 82a. The individual interconnecting hole 93 is individually formed for each of the pressure chambers 61. A +Y-side end edge in each of the lower-surface patterned interconnection 82c, the upper-surface patterned interconnection 82d, and the individual pad 82e corresponding to each other is coupled to the through interconnection 82f in an opening edge of the individual interconnecting hole 93. It should be noted that the individual interconnecting hole 93 can be disposed in a lump to the pressure chambers 61. In this case, the individual interconnecting hole 93 extends in the X direction with the length sufficient to straddle the pressure chambers 61.

As shown in FIG. 4, in the drive interconnections 75, a portion opposed to the flow channel member 52 is covered with the first film 53. Specifically, in the drive interconnections 75, the first common electrodes 81a, the first individual electrodes 82a, the lower-surface patterned interconnections 81c, 82c, and the through interconnections 81f, 82f are covered with the first film 53. In contrast, in the drive interconnection 75, a portion formed on the upper surface of the actuator plate 54 is covered with the second film 55. Specifically, in the drive interconnections 75, the second common electrodes 81b, the second individual electrodes 82b, the upper-surface patterned interconnections 81d, 82d, and the through interconnections 81f, 82f are covered with the second film 55.

To the upper surface of the cover plate 56, there is pressure-bonded a flexible printed board (not shown). The flexible printed board is mounted on the common pads 81e and the individual pads 82e on the upper surface of the cover plate 56.

### [Operation Method of Printer 1]

Then, there will hereinafter be described when recording a character, a figure, or the like on the recording target medium P using the printer 1 configured as described above.

It should be noted that it is assumed that as an initial state, the sufficient ink having colors different from each other is respectively encapsulated in the four ink tanks 4 shown in FIG. 1. Further, there is provided a state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12 of the conveying mechanisms 2, 3. Further, by the carriage 29 moving in the Y direction at the same time, the inkjet heads 5 mounted on the carriage 29 reciprocate in the Y direction.

While the inkjet heads 5 reciprocate, the ink is arbitrarily ejected toward the recording target medium P from each of the inkjet heads 5. Thus, it is possible to perform recording of the character, the image, and the like on the recording target medium P.

Here, the operation of each of the inkjet heads 5 will hereinafter be described in detail.

In such a recirculating side-shoot type inkjet head 5 as in the first embodiment, first, by making the pressure pump 24 and the suction pump 25 shown in FIG. 2 operate, the ink is circulated in the circulation flow channel 23. In this case, the ink circulating through the ink supply tube 21 is supplied to the inside of each of the pressure chambers 61 through the entrance-side common flow channel 65 and the entrance-side communication channels 66. The ink supplied to the inside of each of the pressure chambers 61 circulates through that pressure chamber 61 in the Y direction. Subsequently, the ink is discharged to the exit-side common flow channel 67 through the exit-side communication channels 68, and is then returned to the ink tank 4 through the ink discharge tube 22. Thus, it is possible to circulate the ink between the inkjet head 5 and the ink tank 4.

Then, when the reciprocation of the inkjet heads 5 is started due to the translation of the carriage 29 (see FIG. 1), the drive voltages are applied between the common electrodes 81a, 81b and the individual electrodes 82a, 82b via the flexible printed boards. On this occasion, the common electrodes 81a, 81b are set at a reference potential GND, and the individual electrodes 82a, 82b are set at a drive potential Vdd to apply the drive voltage.

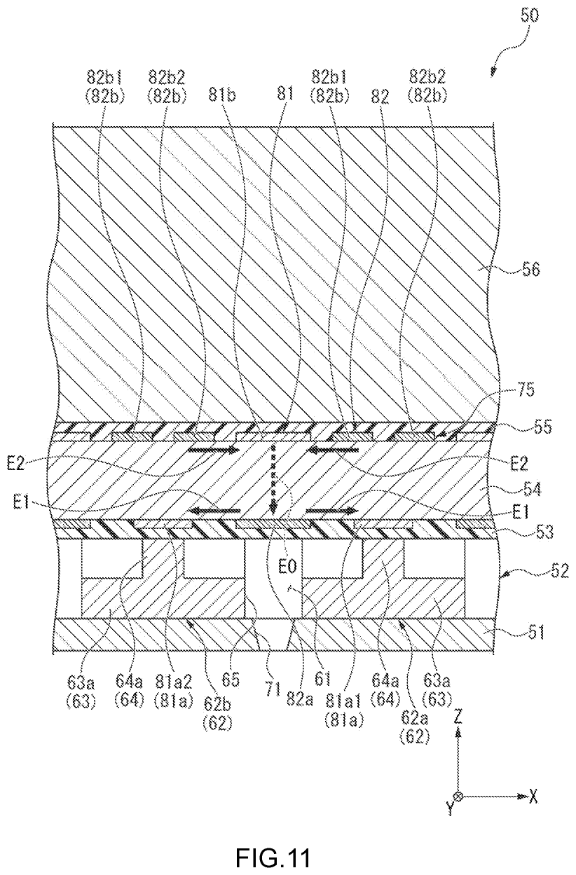

FIG. 11 is an explanatory diagram for explaining a behavior of deformation when ejecting the ink regarding the head chip 50.

As shown in FIG. 11, due to the application of the drive voltage, the potential difference occurs in the X direction between the first common electrodes 81a and the first individual electrode 82a, and between the second common electrode 81b and the second individual electrodes 82b. Due to the potential difference having occurred in the X direction, an electric field occurs in the actuator plate 54 in a direction perpendicular to the polarization direction (the Z direction). As a result, the thickness-shear deformation occurs in the actuator plate 54 in the Z direction due to the shear mode. Specifically, on the lower surface of the actuator plate 54, between the first common electrodes 81a and the first individual electrode 82a, there occurs the electric field in a direction of getting away from each other in the X direction (see the arrows E1). On the upper surface of the actuator plate 54, between the second common electrode 81b and the second individual electrodes 82b, there occurs the electric field in a direction of coming closer to each other in the X direction (see the arrows E2). As a result, in the actuator plate 54, a shear deformation occurs upward in a direction from the both end portions toward the central portion in the X direction in a portion corresponding to each of the pressure chambers 61.

Meanwhile, the potential difference occurs in the Z direction between the first common electrodes 81a and the second individual electrodes 82b, and between the first individual electrode 82a and the second common electrode 81b. Due to the potential difference having occurred in the Z direction, an electric field occurs (see the arrow E0) in the actuator plate 54 in a direction parallel to the polarization direction (the Z direction). As a result, a stretch deformation occurs in the actuator plate 54 in the Z direction due to a bend mode. In other words, in the head chip 50 according to the first embodiment, it results in that both of the deformation caused by the shear mode and the deformation caused by the bend mode in the actuator plate 54 occur in the Z direction. Specifically, due to the application of the drive voltage, the actuator plate 54 deforms in a direction of getting away from the pressure chamber 61. Thus, the volume in the pressure chamber 61 increases. Subsequently, when making the drive voltage zero, the actuator plate 54 is restored to thereby urge the volume in the pressure chamber 61 to be restored. In the process in which the actuator plate 54 is restored, the pressure in the pressure chamber 61 increases, and thus, the ink in the pressure chamber 61 is ejected outside through the nozzle hole 71. By the ink ejected outside landing on the recording target medium P, print information is recorded on the recording target medium P.

### <Method of Manufacturing Head Chip 50>

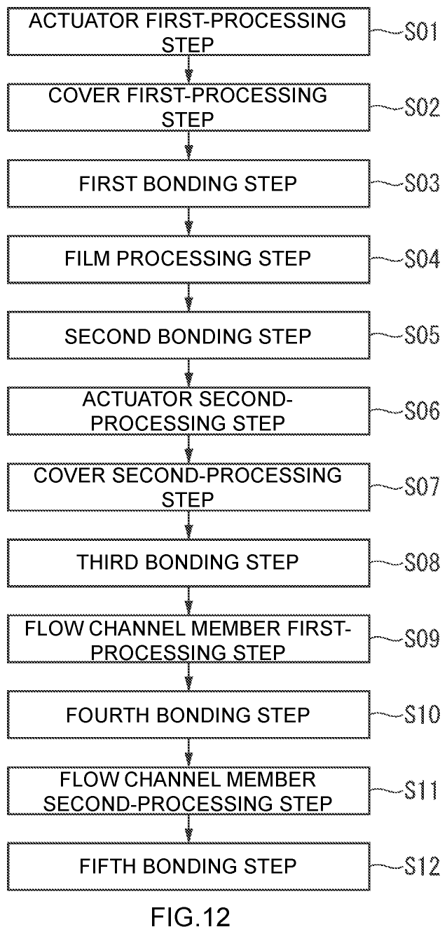

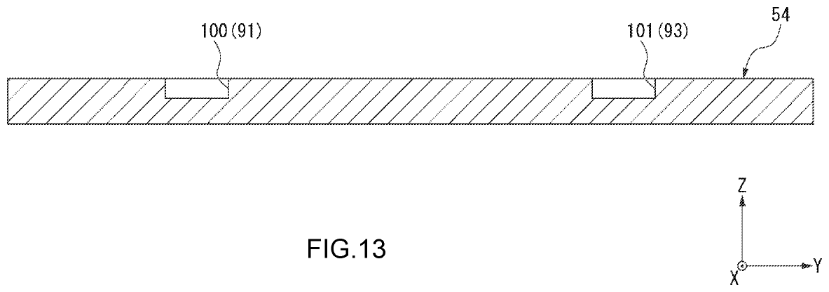

Then, a method of manufacturing the head chip 50 described above will be explained. FIG. 12 is a flowchart for explaining the method of manufacturing the head chip 50. FIG. 13 through FIG. 24 are each a process diagram for explaining the method of manufacturing the head chip 50, and are each a cross-sectional view corresponding to FIG. 4 and FIG. 5. In the following description, there is described when manufacturing the head chip 50 chip by chip as an example for the sake of convenience.

As shown in FIG. 12, the method of manufacturing the head chip 50 is provided with an actuator first-processing step S01, a cover first-processing step S02, a first bonding step S03, a film processing step S04, a second bonding step S05, an actuator second-processing step S06, a cover second-processing step S07, a third bonding step S08, a flow channel member first-processing step S09, a fourth bonding step S10, a flow channel member second-processing step S11, and a fifth bonding step S12.

As shown in FIG. 13, in the actuator first-processing step S01, first, recessed parts 100, 101 which turn to a part of the common interconnecting hole 91 and a part of the individual interconnecting hole 93 are formed (a recessed part formation step). Specifically, a mask pattern in which formation areas of the common interconnecting hole 91 and the individual interconnecting hole 93 open is formed on the upper surface of the actuator plate 54. Subsequently, sandblasting and so on are performed on the upper surface of the actuator plate 54 through the mask pattern. Thus, the recessed parts 100, 101 recessed from the upper surface are provided to the actuator plate 54. It should be noted that the recessed parts 100, 101 can be formed by dicer processing, precision drill processing, etching processing, or the like.

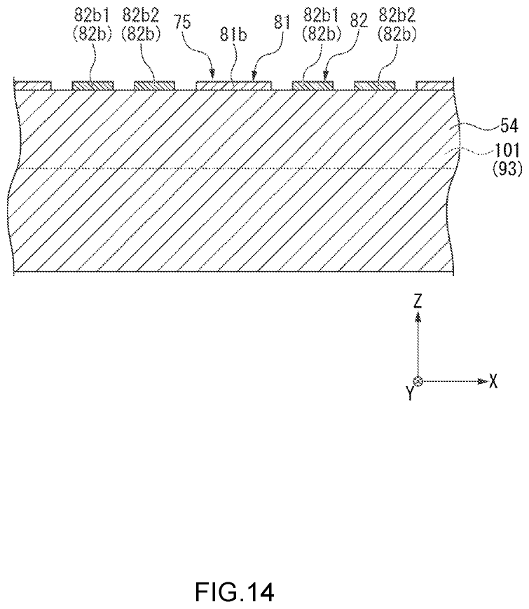

Then, as shown in FIG. 14, in the actuator first-processing step S01, there are formed portions of the drive interconnections 75, the portions being located on the upper surface of the actuator plate 54 (a first interconnection formation step). In the first interconnection formation step, first, a mask pattern in which formation areas of the drive interconnections 75 open is formed on the upper surface of the actuator plate 54. Then, an electrode material is deposited on the actuator plate 54 using, for example, vapor deposition. The electrode material is deposited on the actuator plate 54 through the opening parts of the mask pattern. Thus, the drive interconnections 75 are formed on the upper surface of the actuator plate 54, and the inner surfaces of the recessed parts 100, 101.

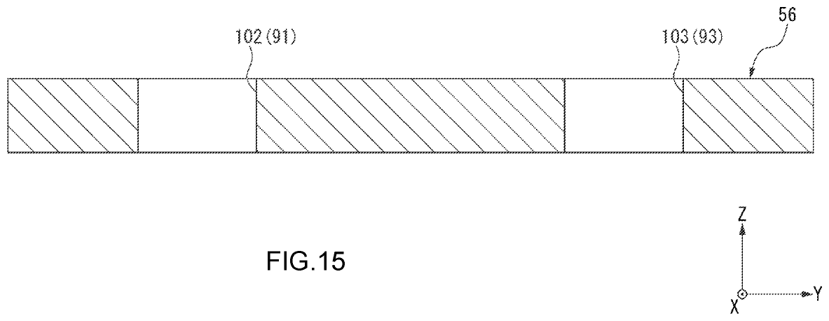

As shown in FIG. 15, in the cover first-processing step S02, through holes 102, 103 which turn to a part of the common interconnecting hole 91 and a part of the individual interconnecting hole 93 are provided to the cover plate 56. The through holes 102, 103 can be formed by the sandblasting, the dicer processing, or the like similarly to the method of providing the recessed parts 100, 101 to the actuator plate 54.

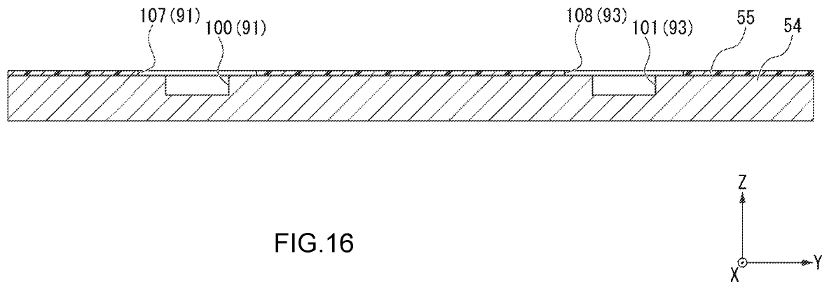

As shown in FIG. 16, in the first bonding step S03, the second film 55 is attached to the upper surface of the actuator plate 54 with an adhesive or the like.

In the film processing step S04, through holes 107, 108 which turn to a part of the common interconnecting hole 91 and a part of the individual interconnecting hole 93 are formed. It is possible to form the through holes 107, 108 by performing, for example, laser processing on portions of the second film 55, the portions overlapping the corresponding recessed parts 100, 101 when viewed from the Z direction. Thus, the recessed parts 100 and the through holes 107 are communicated with each other, and the recessed parts 101 and the through holes 108 are communicated with each other.

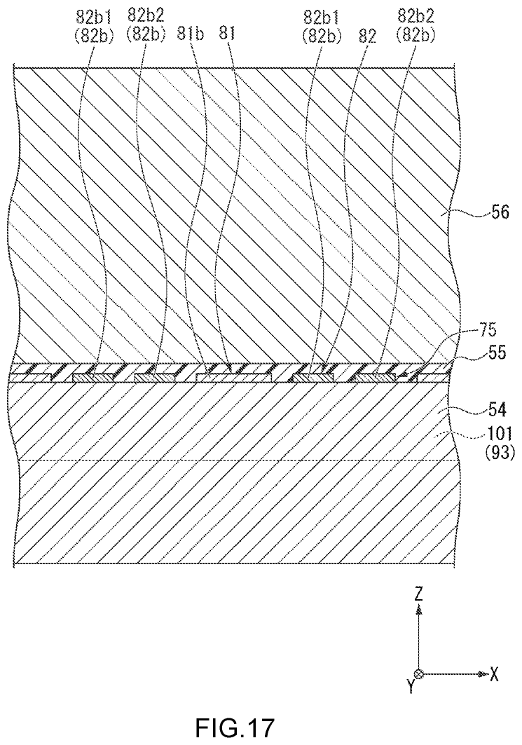

As shown in FIG. 17, in the second bonding step S05, the cover plate 56 is attached to the upper surface of the second film 55 with an adhesive or the like. Thus, the recessed parts 100 and the through holes 102, 107 are communicated with each other, and the recessed parts 101 and the through holes 103, 108 are communicated with each other.

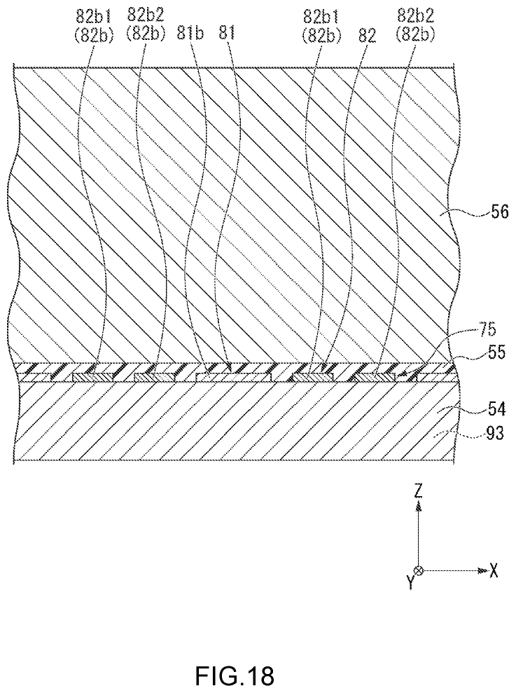

As shown in FIG. 18, in the actuator second-processing step S06, grinding processing is performed on the lower surface of the actuator plate 54 (a grinding step). On this occasion, on the lower surface of the actuator plate 54, the actuator plate 54 is ground up to a position where the recessed parts 100, 101 open to thereby form the common interconnecting holes 91 and the individual interconnecting holes 93.

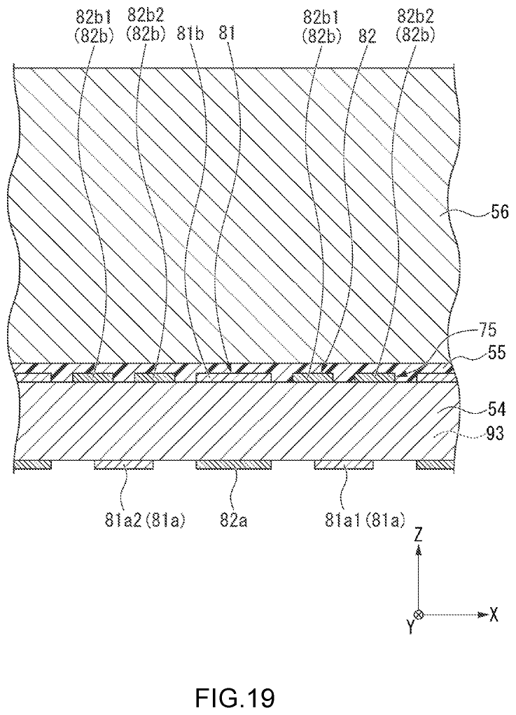

Then, as shown in FIG. 19, in the actuator second-processing step S06, there are formed portions of the drive interconnections 75, the portions being located on the lower surface of the actuator plate 54 and the inner surfaces of the interconnecting holes 91, 93 (a second interconnection formation step). In the second interconnection formation step, first, a mask pattern in which formation areas of the drive interconnections 75 open is formed on the lower surface of the actuator plate 54. Subsequently, an electrode material is deposited on the actuator plate 54 using, for example, vapor deposition. The electrode material is deposited on the actuator plate 54 through the opening parts of the mask pattern. Thus, the drive interconnections 75 are formed on the lower surface of the actuator plate 54, and the inner surfaces of the interconnecting holes 91, 93.

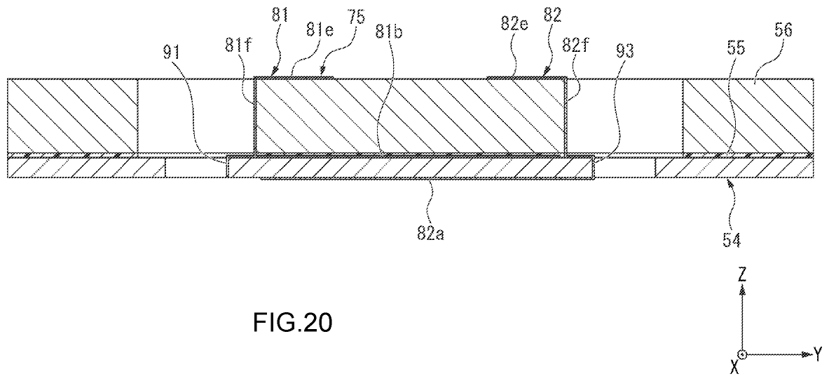

As shown in FIG. 20, in the cover second-processing step S07, the pads 81e, 82e and the through interconnections 81f, 82f are provided to the cover plate 56. Specifically, first, a mask pattern in which formation areas of the pads 81e, 82e and the through interconnections 81f, 82f open is formed on the upper surface of the cover plate 56. Then, the electrode material is deposited on the cover plate 56 using, for example, vapor deposition. The electrode material is deposited on the cover plate 56 through the opening parts of the mask pattern. Thus, the pads 81e, 82e and the through interconnections 81f, 82f are formed.

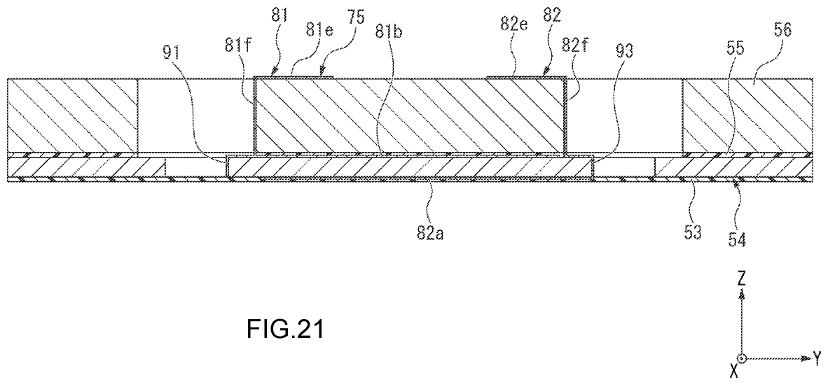

As shown in FIG. 21, in the third bonding step S08, the first film 53 is attached to the lower surface of the actuator plate 54 with an adhesive or the like.

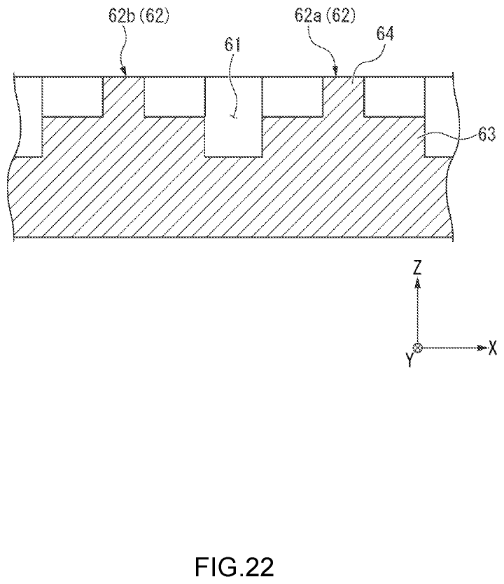

As shown in FIG. 22, in the flow channel member first-processing step S09, the flow channels 60 (see FIG. 6) and the pressure chambers 61 are provided to the flow channel member 52. The flow channels 60 and the pressure chambers 61 are formed by performing, for example, cutting processing by a dicer or sandblasting on the flow channel member 52. Then, portions of the flow channel member 52, the portions each partitioning the pressure chambers 61 adjacent to each other, remain as the partition wall 62.

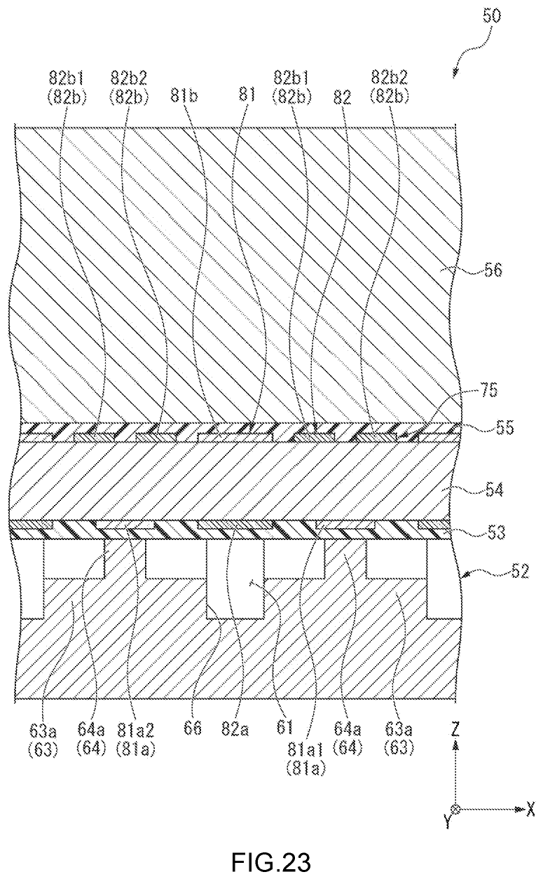

As shown in FIG. 23, in the fourth bonding step S10, the flow channel member 52 is attached to the lower surface of the first film 53 with an adhesive or the like.

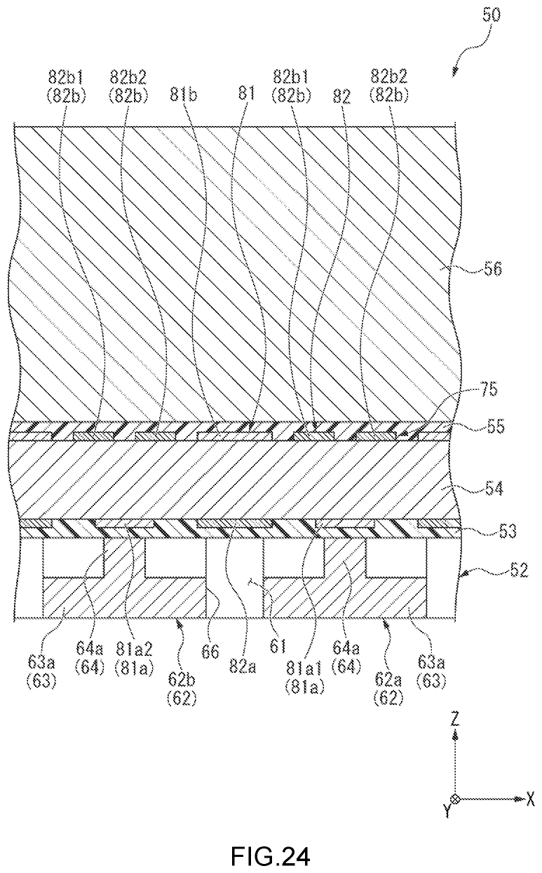

As shown in FIG. 24, in the flow channel member second-processing step S11, the grinding processing is performed on the lower surface of the flow channel member 52 (the grinding step). On this occasion, on the lower surface of the flow channel member 52, the flow channel member 52 is ground up to a position where the flow channels 61 and the pressure chambers 61 open.

In the fifth bonding step S12, the nozzle plate 51 is attached to the lower surface of the flow channel member 52 in a state in which the nozzle holes 71 and the pressure chambers 61 are aligned with each other.

Due to the steps described hereinabove, the head chip 50 is completed.

As described above, the head chip 50 according to the first embodiment is provided with a first member (e.g., the first film 53, the actuator plate 54, and the cover plate 56) bonded on the flow channel member 52 in a state in which the pressure chambers 61 are closed from above (at a first side in a first direction), and a second member (e.g., the nozzle plate 51) bonded on the flow channel member 52 in a state in which the pressure chambers 61 are closed from below (at a second side in the first direction). On that basis, in the head chip 50, there is adopted the configuration in which the bonding area between the partition wall 62 and the nozzle plate 51 is larger than the bonding area between the partition wall 62 and the first film 53.

According to this configuration, it is possible to ensure the rigidity of the partition wall 62 while ensuring the volume of the pressure chamber 61 compared to when the bonding area between the partition wall 62 and the nozzle plate 51 is made equivalent to the bonding area between the partition wall 62 and the first film 53. Thus, it is possible to prevent the deformation of the partition wall 62 when the pressure inside the pressure chamber 61 changes due to the deformation of the actuator plate 54, and therefore, it is possible to effectively transfer the elastic energy to the ink located inside the pressure chamber 61. As a result, it is possible to increase the pressure to be generated by the pressure chamber 61.

In the head chip 50 according to the first embodiment, there is adopted the configuration in which portions (the side walls 62a, 62b) of the partition wall 62, the portions partitioning the pressure chambers 61 adjacent to each other in the X direction (a second direction), each have the stepped shape in which the upper a part is located, the smaller the dimension in the X direction of that part is.

According to this configuration, it is possible to obtain the desired pressure to be generated by the pressure chamber 61 while ensuring the volume of the pressure chamber 61. Further, it is possible to enhance the workability compared to when, for example, forming the side walls 62a, 62b so as to have a taper shape.

In the head chip 50 according to the first embodiment, the common flow channel (e.g., the entrance-side common flow channel 65) is formed in the portion located at one side in the Y direction (a third direction) with respect to the pressure chambers 61, and the communication channels (e.g., the entrance-side communication channels 66) for individually coupling the entrance-side common flow channel 65 and the respective pressure chambers 61 to each other are formed on the end walls (e.g., the +Y-side end walls 62c). On that basis, there is adopted the configuration in which the flow channel cross-sectional area of the communication channel is smaller than the flow channel cross-sectional area of the pressure chamber 61.

According to this configuration, it is possible to make the distance between the entrance-side communication channels 66 adjacent to each other longer compared to the distance between the pressure chambers 61 adjacent to each other. Thus, it is possible to ensure the distance between the pressure chambers 61 through the common flow channel (e.g., the entrance-side common flow channel 65) in the pressure chambers 61 adjacent to each other. Therefore, it is possible to prevent so-called crosstalk that a pressure variation in one pressure chamber 61 is propagated to other pressure chambers 61 through the entrance-side common flow channel 65 and the entrance-side communication channels 66. Moreover, since the flow channel cross-sectional area of the entrance-side communication channel 66 is smaller than the flow channel cross-sectional area of the pressure chamber 61, it is easy to prevent the pressure variation from propagating from the entrance-side common flow channel 65 to the pressure chambers 61 through the entrance-side communication channels 66.

In the head chip 50 according to the first embodiment, there is adopted the configuration in which the flow channel cross-sectional area of the pressure chamber 61 gradually increases in a direction toward an inside in the Y direction.

According to this configuration, it is possible to smoothly circulate the ink flowing into the pressure chamber 61 from, for example, the entrance-side communication channel 66 in the pressure chamber 61.

The head chip 50 according to the first embodiment is provided with the configuration which has the first individual electrodes (first electrodes) 82a formed on the lower surface (a first surface) of the actuator plate 54, the second common electrodes (first opposed electrodes) 81b formed on the upper surface (a second surface) of the actuator plate 54, and the second individual electrodes (second electrodes) 82b formed adjacent to the first common electrodes 81a on the upper surface of the actuator plate 54.

According to this configuration, by generating the potential difference between the second individual electrodes 82b and the second common electrodes 81b, it is possible to generate the electric field in the direction crossing the polarization direction of the actuator plate 54. Thus, by deforming the actuator plate 54 in the Z direction in the shear mode (the roof-shoot type), it is possible to change the volume of the pressure chamber 61. Further, by generating the potential difference between the first individual electrode 82a and the first common electrode 81a, it is possible to generate the electric field also in the polarization direction of the actuator plate 54. Thus, by deforming the actuator plate 54 in the Z direction in the bend mode (a bimorph type), it is possible to change the volume of the pressure chamber 61. In other words, by deforming the actuator plate 54 in the Z direction in both of the shear mode and the bend mode, it is possible to increase the pressure to be generated in the pressure chamber 61 when ejecting the ink.

In the head chip 50 according to the first embodiment, there is adopted the configuration in which the nozzle plate 51 is made of metal.

According to this configuration, since it becomes easy to ensure the rigidity of the nozzle plate 51, it becomes difficult for the nozzle plate 51 to deform when the pressure in the pressure chamber 61 varies due to the deformation of the actuator plate 54. Therefore, the deformation of the actuator plate 54 becomes easy to propagate to the ink, and thus, it is easy to obtain the desired pressure to be generated in the pressure chamber 61.

In the head chip 50 according to the first embodiment, there is adopted the configuration in which the nozzle plate (a jet hole plate) 51 is directly bonded to the lower surface of the flow channel member 52.

According to this configuration, it is possible to form the second member from a single member of the nozzle plate 51. Thus, it is possible to simplify the bonding step (the fifth bonding step) of the second member to the flow channel member 52, and thus, it is possible to achieve a reduction in cost and an increase in yield ratio. Further, by simplifying the fifth bonding step, after assembling the head chip 50, it is possible to prevent an occurrence of a failure of the head chip 50 due to the bonding part.

Since the inkjet head 5 and the printer 1 according to the first embodiment are each equipped with the head chip 50 described above, it is possible to provide the inkjet head 5 and the printer 1 which are high in quality and capable of exerting the desired ejection performance.

### Second Embodiment

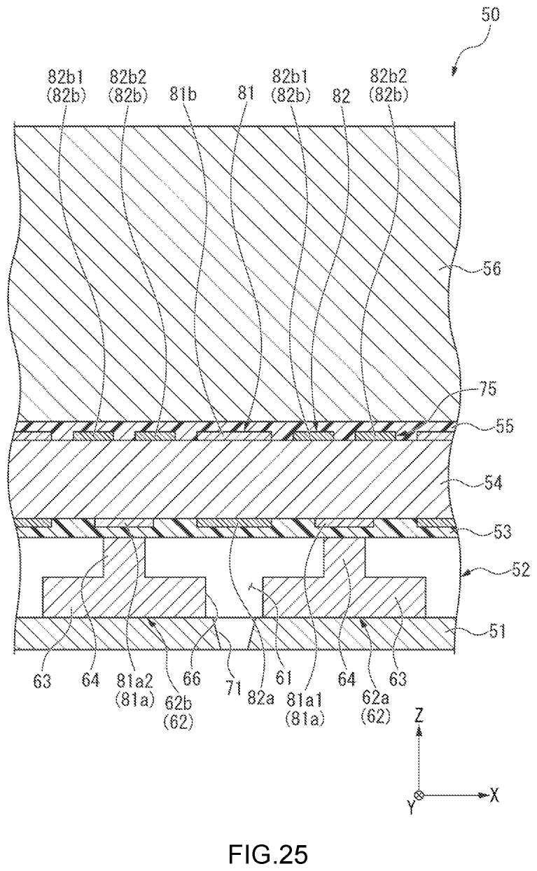

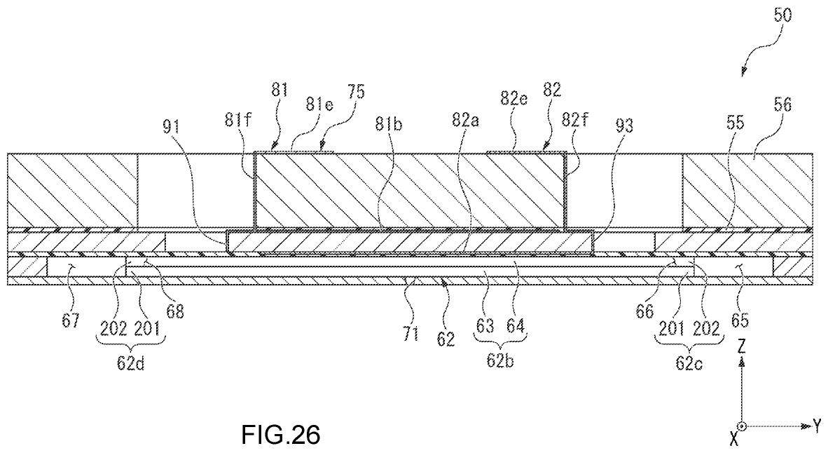

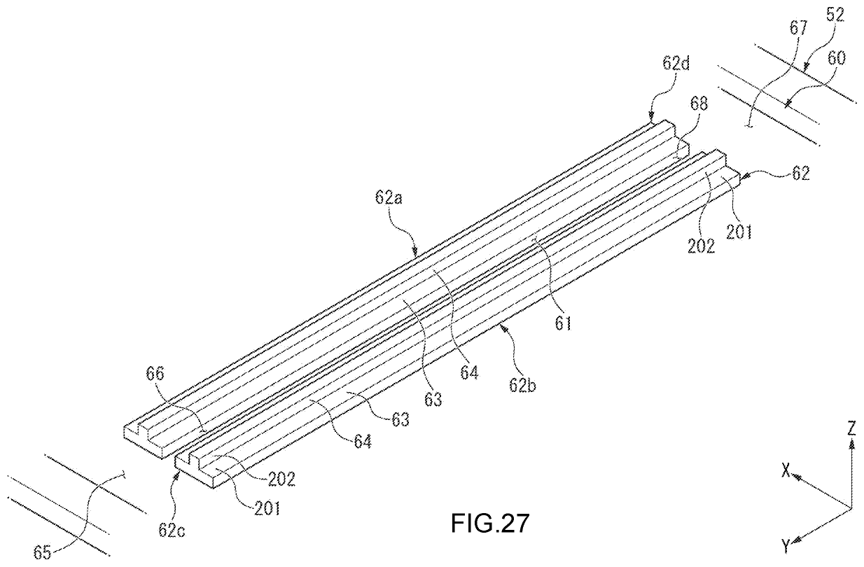

FIG. 25 is a cross-sectional view corresponding to FIG. 4 in a head chip 50 according to a second embodiment. FIG. 26 is a cross-sectional view corresponding to FIG. 5 in the head chip 50 according to the second embodiment. FIG. 27 is a perspective view corresponding to FIG. 6 in the head chip 50 according to the second embodiment.

In the head chip 50 shown in FIG. 25 through FIG. 27, the pressure chambers 61 are each formed to have a T-shape when viewed from the X direction throughout the entire length in the Y direction. Therefore, the flow channel cross-sectional area of the pressure chamber 61 is made uniform throughout the entire length.

The pressure chambers 61 adjacent to each other are partitioned in the X direction by the side walls 62a, 62b. The side walls 62a, 62b are formed to have a stepped shape in which the upper a part is located, the smaller the width in the X direction of that part is. Specifically, in the side walls 62a, 62b, the wide part 63 is formed to have the width in the X direction and the height in the Z direction uniform throughout the entire length in the Y direction. In the side walls 62a, 62b, the narrow part 64 is formed to have the width in the X direction and the height in the Z direction uniform throughout the entire length in the Y direction.

The entrance-side communication channels 66 each penetrate the +Y-side end wall 62c in the Y direction. The exit-side communication channels 68 each penetrate the −Y-side end wall 62d in the Y direction. The entrance-side communication channels 66 and the exit-side communication channels 68 are formed to have the shapes equivalent to that of the pressure chamber 61 when viewed from the X direction. In other words, the end walls 62c, 62d are formed so that the outer shapes thereof viewed from the Y direction are equivalent to those of the side walls 62a, 62b. Specifically, the end walls 62c, 62d are formed to have a stepped shape in which the upper a part is located, the smaller the width in the X direction of that part is. The end walls 62c, 62d are respectively provided with an end wall wide part 201 and an end wall narrow part 202. It should be noted that in the second embodiment, the +Y-side end wall 62c is a portion located at an outer side in the Y direction of the individual interconnecting hole 93. The −Y-side end wall 62d is a portion located at the outer side in the Y direction of the common interconnecting hole 91.

The end wall wide part 201 is connected in the Y direction with respect to the wide part 63 of each of the side walls 62a, 62b. In the end wall wide part 201, the width in the X direction and the height in the Z direction are made equivalent to those of the wide part 63 of each of the side walls 62a, 62b.

The end wall narrow part 202 protrudes upward from a central portion in the X direction of the end wall wide part 201 with respect to each of the side walls 62a, 62b. The end wall narrow part 202 is connected in the Y direction with respect to the narrow part 64 of each of the side walls 62a, 62b. In the end wall narrow part 202, the width in the X direction and the height in the Z direction are made equivalent to those of the narrow part 64 of each of the side walls 62a, 62b.

According also to the second embodiment, since it is possible to make the bonding area between the partition wall 62 and the nozzle plate 51 larger than the bonding area between the partition wall 62 and the first film 53, it is possible to ensure the rigidity of the partition wall 62 while ensuring the volume of the pressure chamber 61. Thus, it is possible to prevent the deformation of the partition wall 62 when the pressure inside the pressure chamber 61 changes due to the deformation of the actuator plate 54, and therefore, it is possible to effectively transfer the elastic energy to the ink located inside the pressure chamber 61. As a result, it is possible to increase the pressure to be generated by the pressure chamber 61.

### Third Embodiment

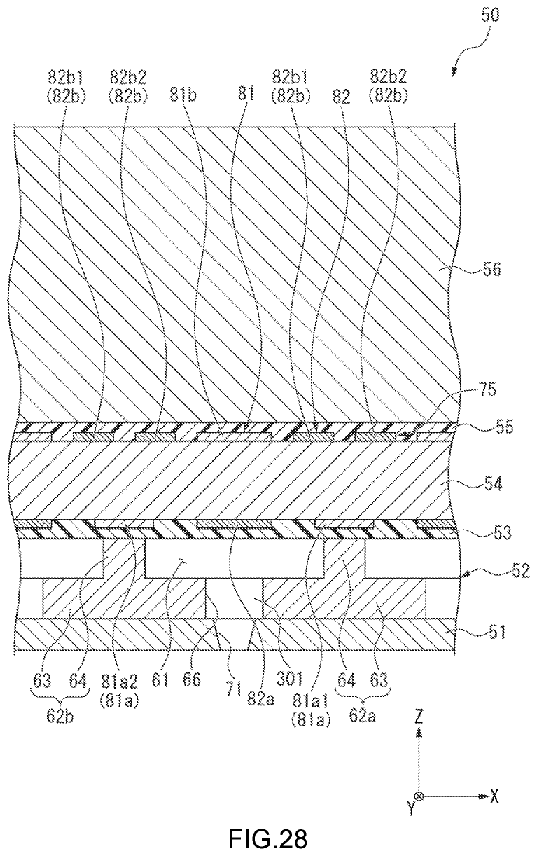

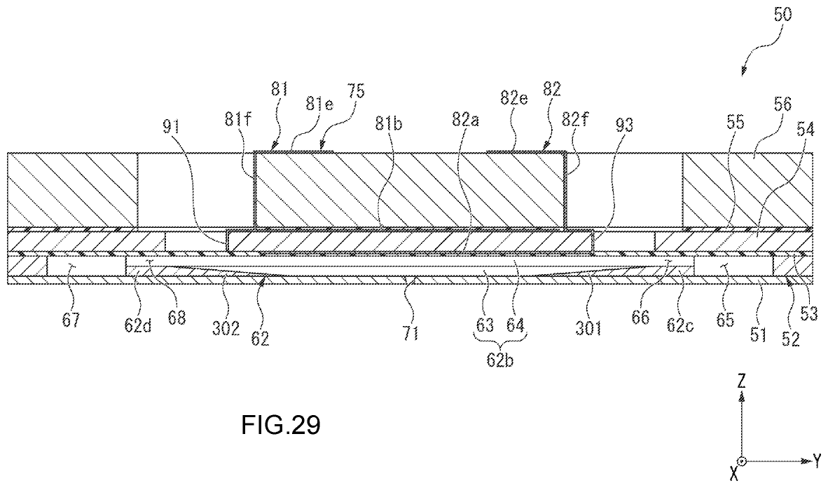

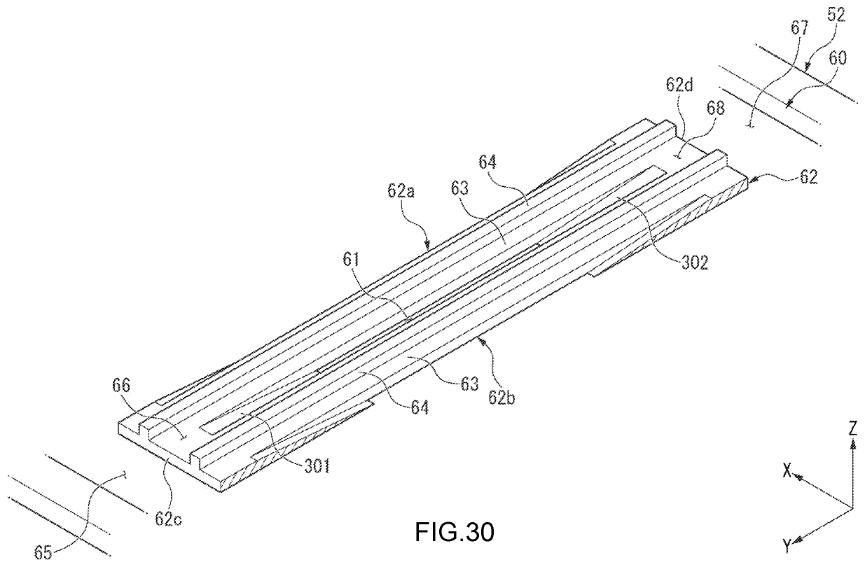

FIG. 28 is a cross-sectional view corresponding to FIG. 4 in a head chip 50 according to a third embodiment. FIG. 29 is a cross-sectional view corresponding to FIG. 5 in the head chip 50 according to the third embodiment. FIG. 30 is a perspective view corresponding to FIG. 6 in the head chip 50 according to the third embodiment.

In the head chip 50 shown in FIG. 28 through FIG. 30, the partition wall 62 is provided with a +Y-side coupling part 301 for coupling the +Y-side end portions in the side walls 62a, 62b facing each other to each other, and a −Y-side coupling part 302 for coupling the −Y-side end portions in the side walls 62a, 62b facing each other to each other.

The +Y-side coupling part 301 faces the inside of each of the pressure chambers 61. In the +Y-side coupling part 301, the height in the Z direction gradually increases in a direction toward the +Y side. Specifically, a lower surface of the +Y-side coupling part 301 is arranged coplanar with the lower surface of the wide part 63. An upper surface of the +Y-side coupling part 301 is formed to have a curved surface (a tilted surface) extending upward in a direction toward the +Y side. A maximum height of the +Y-side coupling part 301 is made equivalent to the height of the wide part 63 at +Y-side end edges of the side walls 62a, 62b.

The −Y-side coupling part 302 faces the inside of each of the pressure chambers 61. In the −Y-side coupling part 302, the height in the Z direction gradually increases in a direction toward the −Y side. Specifically, a lower surface of the −Y-side coupling part 302 is arranged coplanar with the lower surface of the wide part 63. An upper surface of the −Y-side coupling part 302 is formed to have a curved surface (a tilted surface) extending upward in a direction toward the −Y side. A maximum height of the −Y-side coupling part 301 is made equivalent to the height of the wide part 63 at −Y-side end edges of the side walls 62a, 62b.

The coupling parts 301, 302 are separated in the Y direction from each other. Therefore, the pressure chambers 61 penetrate the flow channel member 52 in a central portion in the Y direction. Further, the nozzle holes 71 are communicated with the respective pressure chambers 61 at positions not overlapping the coupling parts 301, 302 in the plan view. It should be noted that the flow channel cross-sectional area of the pressure chamber 61 gradually increases in a direction toward the central portion in the Y direction.

The entrance-side communication channels 66 each penetrate an upper part of the +Y-side end wall 62c in the Y direction. The exit-side communication channels 68 each penetrate an upper part of the −Y-side end wall 62d in the Y direction. The depth in the Z direction of the entrance-side communication channels 66 and the exit-side communication channels 68 is made equivalent to the height in the Z direction of the narrow part 64. The dimensions in the X direction of the entrance-side communication channels 66 and the exit-side communication channels 68 are made equivalent to the distance between the narrow parts 64 adjacent to each other. Therefore, the flow channel cross-sectional area of each of the entrance-side communication channels 66 and the exit-side communication channels 68 is made smaller than the maximum flow channel cross-sectional area of the pressure chamber 61.

According to the third embodiment, substantially the same functions and advantages as in the embodiments described above are exerted, and in addition, the following functions and advantages are exerted.

Specifically, since the side walls 62a, 62b facing opposed to each other are coupled to each other with the coupling parts 301, 302, it is possible to increase the rigidity of the partition wall 62. As a result, it is possible to prevent the deformation of the partition wall 62 when the pressure inside the pressure chamber 61 changes due to the deformation of the actuator plate 54, and therefore, it is possible to effectively transfer the elastic energy to the ink located inside the pressure chamber 61. Therefore, it is possible to increase the pressure to be generated by the pressure chamber 61.

Moreover, since the side walls 62a, 62b opposed to each other are not separated when processing the lower surface of the flow channel member 52 in the flow channel member second-processing step S11, it is possible to achieve an increase in manufacturing efficiency and yield ratio.

### Fourth Embodiment

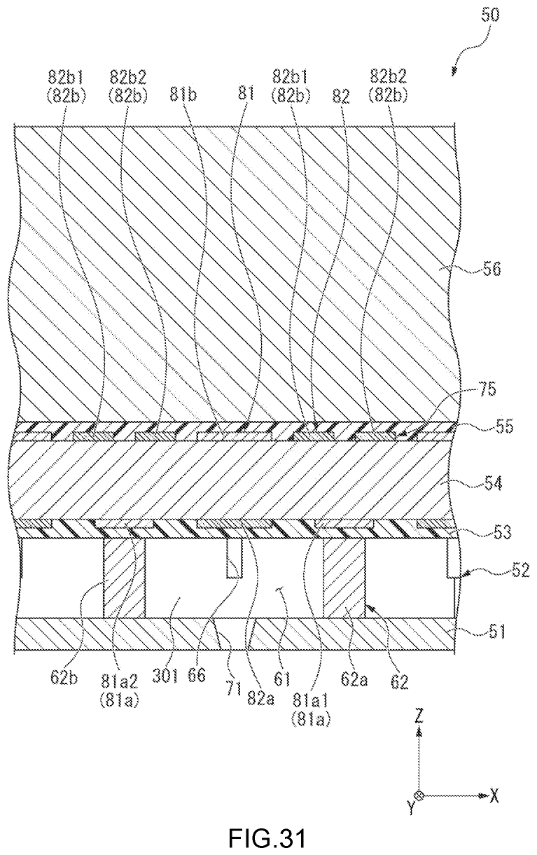

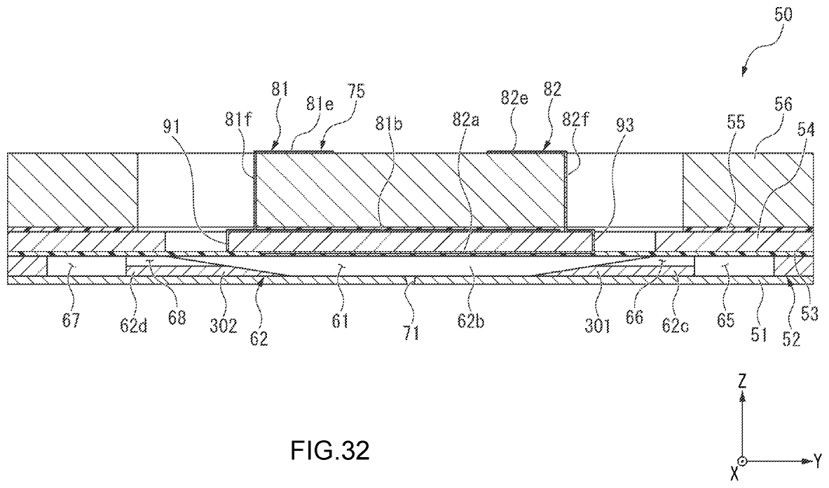

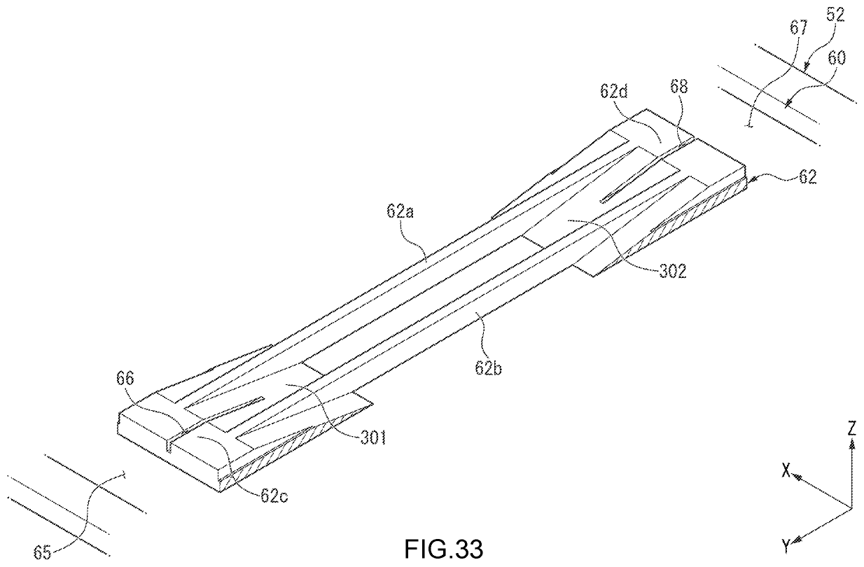

FIG. 31 is a cross-sectional view corresponding to FIG. 4 in a head chip 50 according to a fourth embodiment. FIG. 32 is a cross-sectional view corresponding to FIG. 5 in the head chip 50 according to the fourth embodiment. FIG. 33 is a perspective view corresponding to FIG. 6 in the head chip 50 according to the fourth embodiment.

In the head chip 50 shown in FIG. 31 through FIG. 33, the side walls 62a, 62b are formed so that the width in the X direction is uniform throughout the entire length in the Y direction and the Z direction.

The +Y-side coupling part 301 couples the +Y-side end portions of the side walls 62a, 62b facing each other to each other. In the +Y-side coupling part 301, the height in the Z direction gradually increases in a direction toward the +Y side. A maximum height of the +Y-side coupling part 301 is made equivalent to the height of the side walls 62a, 62b at the +Y-side end edges of the side walls 62a, 62b.

The −Y-side coupling part 302 couples the −Y-side end portions of the side walls 62a, 62b facing each other to each other. In the −Y-side coupling part 302, the height in the Z direction gradually increases in a direction toward the −Y side. A maximum height of the −Y-side coupling part 302 is made equivalent to the height of the side walls 62a, 62b at the −Y-side end edges of the side walls 62a, 62b.

The entrance-side communication channels 66 each penetrate a central portion in the X direction along the Y direction in an upper part of the +Y-side end wall 62c and an upper part of the +Y-side coupling part 301. The exit-side communication channels 68 each penetrate a central portion in the X direction along the Y direction in an upper part of the −Y-side end wall 62d and an upper part of the −Y-side coupling part 302. The depth in the Z direction of the entrance-side communication channels 66 and the exit-side communication channels 68 is made shallower than the height of the side walls 62a, 62b. The dimensions in the X direction of the entrance-side communication channels 66 and the exit-side communication channels 68 are made shorter than the distance between the side walls 62a, 62b adjacent to each other. Therefore, the flow channel cross-sectional area of each of the entrance-side communication channels 66 and the exit-side communication channels 68 is made smaller than the maximum flow channel cross-sectional area of the pressure chamber 61.

### Other Modified Examples

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording device, but the liquid jet recording device is not limited to the printer. For example, a facsimile machine, an on-demand printing machine, and so on can also be adopted.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiments described above, there is explained when the recording target medium P is paper, but this configuration is not a limitation. The recording target medium P is not limited to paper, but can also be a metal material or a resin material, and can also be food or the like.

In the embodiments described above, there is explained the configuration in which the liquid jet heads are installed in the liquid jet recording device, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, there is explained the configuration in which the Z direction coincides with the gravitational direction, but this configuration is not a limitation, and it is also possible to set the Z direction to a direction along the horizontal direction.

In the embodiments described above, there is described the configuration in which the actuator plate 54 is deformed due to both of the shear deformation mode and the bend deformation mode, but this configuration is not a limitation. It is sufficient for the head chip 50 according to the present disclosure to have a configuration in which at least the actuator plate 54 deforms in the Z direction.

In the embodiments described above, there is explained the configuration (so-called pulling-shoot) of deforming the actuator plate 54 in the direction of increasing the volume of the pressure chamber 61 due to the application of the drive voltage, and then restoring the actuator plate 54 to thereby eject the ink, but this configuration is not a limitation. It is possible for the head chip according to the present disclosure to be provided with a configuration (so-called pushing-shoot) in which the ink is ejected by deforming the actuator plate 54 in a direction of reducing the volume of the pressure chamber 61 due to the application of the voltage. When performing the pushing-shoot, the actuator plate 54 deforms so as to bulge toward the inside of the pressure chamber 61 due to the application of the drive voltage. Thus, the volume in the pressure chamber 61 decreases to increase the pressure in the pressure chamber 61, and thus, the ink located in the pressure chamber 61 is ejected outside through the nozzle hole 71. When setting the drive voltage to zero, the actuator plate 54 is restored. As a result, the volume in the pressure chamber 61 is restored. It should be noted that the head chip of the pushing-shoot type can be realized by inversely setting either one of the polarization direction and the electric field direction (the layout of the common electrodes and the individual electrodes) of the actuator plate 54 with respect to the head chip of the pulling-shoot type.

In the embodiments described above, there is explained the configuration in which the common flow channels 65, 67 are arranged at the both sides in the Y direction with respect to the pressure chambers 61, but this configuration is not a limitation. The common flow channels 65, 67 can be arranged above the pressure chambers 61.

In the embodiments described above, there is described the configuration in which the actuator plate 54 is bonded above the flow channel member 52 via the first film 53, but this configuration is not a limitation. The actuator plate 54 can directly be bonded above the flow channel member 52.

In the embodiments described above, there is described the configuration in which the nozzle plate 51 is directly bonded below the flow channel member 52, but this configuration is not a limitation. The nozzle plate 51 can be bonded below the flow channel member 52 via an intermediate plate.

In the first embodiment and so on described above, there is described the configuration in which the side walls 62a, 62b are formed to have the stepped shape, but this configuration is not a limitation. The side walls 62a, 62b can be formed to have a taper shape or the like.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
a flow channel member in which a plurality of pressure chambers penetrating in a first direction is arranged in a second direction crossing the first direction;
a first member which includes an actuator plate deformable in the first direction, and which is bonded on the flow channel member in a state of closing the pressure chambers from a first side in the first direction; and
a second member which includes a jet hole plate provided with jet holes communicated with the pressure chambers, and which is bonded on the flow channel member in a state of closing the pressure chambers from a second side as an opposite side to the first side in the first direction, wherein
the flow channel member includes a partition wall configured to partition the pressure chambers adjacent to each other, and
a bonding area between the partition wall and the second member is larger than a bonding area between the partition wall and the first member.

2. The head chip according to claim 1, wherein
a portion of the partition wall, the portion partitioning the pressure chambers adjacent to each other in the second direction, is formed to have a stepped shape in which closer to the first side in the first direction a part is located, smaller a dimension in the second direction of that part is.

3. The head chip according to claim 1, wherein
a common flow channel is formed in a portion of the flow channel member, the portion being located at one side with respect to the pressure chambers in a third direction crossing the second direction when viewed from the first direction,
a plurality of communication channels which extend in the third direction, and which are configured to individually couple the common flow channel and the pressure chambers to each other is provided to the partition wall, and
a flow channel cross-sectional area perpendicular to the third direction of the communication channel is smaller than a flow channel cross-sectional area perpendicular to the third direction of the pressure chamber.

4. The head chip according to claim 3, wherein
the flow channel cross-sectional area perpendicular to the third direction of the pressure chamber gradually increases as getting away from the communication channel in the third direction.

5. The head chip according to claim 1, wherein
the flow channel member includes a coupling part configured to couple portions of the partition wall to each other, the portions facing each other in a direction crossing the first direction, the coupling part facing the pressure chamber, and being located at a position failing to overlap the jet hole when viewed from the first direction.

6. The head chip according to claim 1, wherein
a polarization direction of the actuator plate is set in the first direction, and the actuator plate includes:
a first electrode formed on a first surface of the actuator plate, the first surface facing to the first side in the first direction,
a first opposed electrode which is formed on a second surface of the actuator plate so as to be opposed to the first electrode, the second surface facing to the second side in the first direction, and which is configured to generate a potential difference from the first electrode, and
a second electrode which is formed on the second surface of the actuator plate so as to be adjacent to the first opposed electrode, and which is configured to generate a potential difference from the first opposed electrode.

7. The head chip according to claim 1, wherein
the jet hole plate is made of metal.

8. The head chip according to claim 1, wherein
the jet hole plate is directly bonded to the flow channel member.

9. A liquid jet head comprising:
the head chip according to claim 1.

10. A liquid jet recording device comprising:
the liquid jet head according to claim 9.
